(19) United States
(12) Patent Application Publication
(10) Pub. No.: US 2026/0021469 A1
(43) Pub. Date: Jan. 22, 2026

(54) POROUS SUPRAMOLECULAR CRYSTALS AND METHODS OF MAKING AND USING THE SAME FOR HYDROGEN STORAGE

(71) Applicant: Northwestern University, Evanston, IL (US)

(72) Inventors: James Fraser Stoddart, Evanston, IL (US); Ruihua Zhang, Evanston, IL (US)

(21) Appl. No.: 19/275,750

(22) Filed: Jul. 21, 2025

Related U.S. Application Data
(60) Provisional application No. 63/673,595, filed on Jul. 19, 2024.

(51) Int. Cl. B01J 20/22; B01J 20/28; C01B 3/00

(52) U.S. Cl. CPC B01J 20/22; B01J 20/28066; B01J 20/28073; B01J 20/28076; B01J 20/2808; C01B 3/0015

(57) ABSTRACT

A porous supramolecular crystal having a catenated superstructure and methods of making and using the same are disclosed.

### CROSS-REFERENCE TO RELATED APPLICATION

This application claims benefit of priority to U.S. Patent Application Ser. No. 63/673,595, filed Jul. 19, 2024. The contents of which are incorporated herein by reference.

### BACKGROUND

Hydrogen has been widely regarded as the fuel of the future on account of its zero-emission and high gravimetric energy density compared to that of gasoline. The low volumetric density of hydrogen, however, requires 700-bar compressed tanks for its current storage and transportation, leading to a situation that is not only costly but also raises safety concerns. In order to enable the widespread adoption of fuel cell vehicles (FCVs) powered by hydrogen, the US Department of Energy (DOE) has established metrics10—a gravimetric storage capacity of 6.5 wt % and a volumetric storage capacity of 50 g L⁻¹—for developing hydrogen-storage systems. It is worth noting that the DOE system-level targets for H2 storage take into account the mass and volume of the entire storage system. It is, therefore, desirable to develop storage materials that exceed as much as possible the system-level targets. One promising strategy for reaching these targets is to develop porous adsorbent materials, such as metal-organic frameworks¹⁻³ (MOFs), covalent organic frameworks⁴⁻⁶ (COFs), and porous organic polymers^{7,8} (POPs) for hydrogen storage at reduced pressure, e.g., within 100 bar.

Hydrogen storage has experienced significant progress^{1,11-15} with many adsorbent materials exceeding the gravimetric DOE target of 6.5 wt %. Most materials have limited volumetric capacity, however, with very few balancing⁹ the volumetric (50 g L⁻¹) and gravimetric DOE targets. From an industrial point of view, volume often plays a more important role than weight. Firstly, the volume of the storage tank is limited in automobiles. Secondly, the volumetric capacity of a hydrogen storage system has a more significant impact⁹ on the driving range of FCVs than does the gravimetric capacity. Hence, it is crucial to develop hydrogen adsorbents that can achieve the highest possible attainable volumetric capacity, whilst maintaining an excellent gravimetric capacity, for hydrogen storage.

In order to obtain better than satisfactory volumetric and gravimetric capacities for hydrogen simultaneously, one key step is to strike a balance between high volumetric surface area (VSA) and large gravimetric surface area (GSA) in one and the same material.

### BRIEF SUMMARY OF THE INVENTION

The present technology is directed to a porous supramolecular crystal having a catenated superstructure. In some embodiments, the porous supramolecular crystal has a pore diameter from 1.0 to 1.9 nm. In some embodiments, the porous supramolecular crystal has a gravimetric surface area (GSA) of at least 1500 m² g⁻¹ or at least 2000 m² g⁻¹. In some embodiments, the porous supramolecular crystal has a volumetric surface area (VSA) of at least 1500 m² cm⁻³ or at least 1800 m² cm⁻³. In some embodiments, the porous supramolecular crystal. The porous supramolecular crystal may have a gravimetric capacity of at least 5.0 wt %. In some embodiments, the porous supramolecular crystal has a volumetric capacity of at least 30 g L⁻¹.

The porous supramolecular crystal may have a thermal stability of at least 150° C. In some embodiments, the porous supramolecular crystal has a total pore volume of at least 0.8 cm³ g⁻¹. In some embodiments, the porous supramolecular crystal has two or more properties selected from the group selected from a pore diameter from 1.0 to 1.9 nm, a gravimetric surface area of at least 1500 m² g⁻¹, a volumetric surface area of at least 1500 m² g⁻¹, a gravimetric capacity of at least 5.0 wt %, a volumetric capacity of at least 30 g L⁻¹, a thermal stability of at least 150° C., and a total pore volume of at least 0.8 cm³ g⁻¹.

The porous supramolecular crystal may include a plurality of triptycene moieties. In some embodiments, the plurality of triptycene moieties includes a plurality of imidazole-annulated triptycene hexaacid moieties.

In some embodiments, the porous supramolecular crystal is prepared from IATH-1 or IATH-2. In some embodiments, the porous supramolecular crystal is RP-H101 or RP-H100. In some embodiments, the porous supramolecular crystal includes D₃ₕ symmetry. In some embodiments, the porous supramolecular crystal includes a 7-fold catenated topology.

In some embodiments, the catenated superstructure includes a plurality of catenated components, wherein the catenated components have a primary surface (P) parallel to a normal direction (\vec{n}) and a secondary surface (S) perpendicular to the normal direction and the catenated components have a primary surface width (wₚ) that is wider than a secondary surface width (wₛ).

The present technology is further directed to a method for storing hydrogen, the method including contacting the porous supramolecular crystal with hydrogen under conditions sufficient for adsorbing hydrogen, optionally wherein the method further comprises desorbing the hydrogen.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIGS. 1A-F show catenation analysis and crystal superstructures of RP-H100 and RP-H101. A. Schematics of a catenated component with primary and secondary surfaces oriented parallel and perpendicular, respectively, to the normal direction (\vec{n}). The light grey regions represent the potential loss of accessible surface areas during catenation. The loss is reduced significantly when the widths (wₚ) of the primary surfaces are much smaller than those (wₛ) of the secondary surfaces compared with the opposite situation (wₚ>>wₛ). B. and C. Structural formulae for IATH-1 and IATH-2. Peripheral extension of IATH-1 by introducing three acetylenic linkages (in black frame) leads to IATH-2. The building blocks are simplified by introducing the trigonal planar model to describe IATH-1 or IATH-2. D. A representative hexagonal unit present in RP-H100 composed of nine IATH-1 building blocks held together by [O—H . . . O] hydrogen bonds having a diameter of 5.6 nm. E. The simplified model of the representative hexagon is displayed using nine trigonal planar models. Each hexagon has three open channels indicated by black arrows. Each open channel can be considered as a catenated component (FIG. 1A, D) with wₚ<<wₛ. The hexagonal units are connected in the xy-plane by [O—H . . . O] hydrogen bonds, resulting in an infinite two-dimensional (2D) layer, which assembles into 3D interconnected honeycomb-like frameworks along the z-axis. F. The interaction details of hydrogen-bond directed catenation.

FIGS. 2A-C show interpenetration analysis of RP-H100 and RP-H101. A. The interpenetrated patterns of two honeycomb frameworks through the open channels directed by [N—H . . . O] and [O—H . . . N] hydrogen bonds. The zoomed-in circle shows an enhanced view of the layer-to-layer catenation. B. Within each layer, each hexagonal motif, e.g., dark grey hexagon, is interpenetrated by six other hexagons, through the open channels. The zoomed-in circle shows the details of the interpenetrated superstructure. C. Top view of the 7-fold catenated topology of RP-H101. The other six layered components interpenetrated labelled I, II, III, IV, V and VI, respectively. RP-H100 and RP-H101 share the same topological superstructure.

FIGS. 3A-D show stability analysis of RP-H101. A. PXRD Patterns for the as-synthesized, activated, and after-adsorption RP-H101 show good agreement with the simulated patterns obtained from single-crystal superstructures, indicating the bulk purity and permanent porosity of RP-H101. B. PXRD Patterns for RP-H101 were retained after soaking in different solvents for 24 h, demonstrating the high chemical stability of RP-H101. C. Variable temperature PXRD (VT-PXRD) of RP-H101 reveals that the crystallinity of RP-H101 is retained up to 375° C. with no phase change being observed. D. Thermogravimetric profiles of the as-synthesized (black line) and activated (grey line) RP-H101. The first weight loss step for the as-synthesized RP-H101 corresponds to free solvent release. At around 380° C., a sharp weight loss occurs, corresponding to the decomposition of the material.

FIGS. 4A-D show porosity characterization and trade-off properties of RP-H100 and RP-H101. A. The experimental and simulated N₂ adsorption isotherms for RP-H100 and RP-H101 at 77 K, respectively. STP refers to standard temperature and pressure. B. The pore size distribution and pore volume of RP-H101 were calculated from N₂ adsorption isotherms (77 K) using the NLDFT method³³. The 1.6-nm pores and 1.9-nm channels are denoted by spheres. C. Trade-off between thermal stability and gravimetric surface areas (GSAs) for all the HOFs with GSAs higher than 1500 m² g⁻¹ published in the literature to date. D. Trade-off between GSAs and volumetric surface areas (VSAs) for HOFs in (C).

FIGS. 5A-D show high-pressure H₂ storage capacity of RP-H100 and RP-H101. A, B. Experimental and simulated gravimetric total uptake of H₂ in RP-H100 (A) and RP-H101 (B) at 77, 160, and 296 K, respectively. C. Volumetric total uptake of H₂ in RP-H100 and RP-H101 at 77, 160, and 296 K, respectively. D. The trade-off between the gravimetric and volumetric deliverable capacities of H₂ in RP-H100, RP-H101 and MOFs under the swing conditions of temperature and pressure: 77 K/100 bar 160 K/5 bar. The purple region represents the gravimetric and volumetric performances that surpass 6.5 wt % and 50 g L⁻¹, respectively.

FIGS. 6A-6E show A. and B. Structural formulas and crystal superstructure of IATH-1 molecule. C. The crystal superstructure of a 5.6-nm hexagonal motif assembled from nine IATH-1 molecules in RP-H100. The side-view of the hexagonal structure shows a connection channel linked by four hydrogen bonds. The width and height of the connection channel are 3.1 and 1.4 nm. D and E. The structural formulas and crystal superstructures show the [O—H . . . O] hydrogen bonds that drive the formation of hexagonal motifs. The hydrogen bonds are represented by light dotted lines.

FIGS. 7A-7E show A. and B. Structural formulas and crystal superstructure of the IATH-2 molecule. C. The crystal superstructure of a 6.4-nm hexagonal motif assembled from nine IATH-2 molecules in RP-H101. The side-view of the hexagonal motif shows a connection channel linked by four hydrogen bonds. The width and height of the connection channel are 3.5 and 1.4 nm. D. and E. The structural formulas and crystal superstructures show the [O—H . . . O] hydrogen bonds that drive the formation of the 6.4-nm hexagonal motifs. The hydrogen bonds arc represented by light dotted lines.

FIGS. 8A-8E show A. The crystal superstructure of RP-H100 shows the interpenetration of 5.6-nm. After interpenetration, every 5.6-nm hexagonal motif forms 12 triangular modules. B. and C. The top-view and side-view of how the triangular module is assembled. Each triangular module shows a three-layer structure assembled with five IATH-1 molecules. D. Each triangular module has a triangular prism-shaped pore, with a diameter of 1.2 nm. E. From the side-view of the triangular module, there are six [N—H . . . O] and six [O—H . . . N] hydrogen bonds between these five IATH-1 molecules, directing the formation of highly catenated superstructure.

FIGS. 9A-9E show A. The crystal superstructure of RP-H100 shows that seven 5.6-nm hexagonal motifs. After interpenetration, every 5.6-nm hexagonal motif forms seven smaller hexagonal modules. B and C. The top-view and side-view of how the small hexagonal module is assembled. The small hexagonal module shows a three-layer structure and a pore diameter of 1.7 nm, assembled with nine IATH-1 molecules. D and E. Based on the top-view and side-view of a small hexagonal module, there are 12 [N—H . . . O] and 12 [O—H . . . N] hydrogen bonds between these nine IATH-1 molecules, which directs the interpenetration and the formation of the highly catenated superstructure.

FIGS. 10A-10E show A. The crystal superstructure of RP-H101 shows that seven 6.4-nm hexagonal motifs. After interpenetration, every 6.4-nm hexagonal motif forms seven smaller hexagonal modules. B and C. The top-view and side-view of how the small hexagonal module is assembled. The small hexagonal module shows a three-layer structure and a pore diameter of 1.8 nm, assembled with nine IATH-2 molecules. D. and E. Based on the top view and side view of a small hexagonal module, there are 12 [N—H . . . O] and 12 [O—H . . . N] hydrogen bonds between these nine IATH-2 molecules, which directs the interpenetration and the formation of the highly catenated structure.

FIGS. 11A-11E show A. The crystal superstructure of RP-H101 shows the interpenetration of 6.4-nm hexagonal motifs. After interpenetration, every 6.4-nm hexagonal motif forms 12 triangular modules. B and C. The top-view and side-view of how the triangular module is assembled. Each triangular module shows a three-layer structure assembled with five IATH-2 molecules. D. Each triangular module has a triangular prism-shaped pore, with a pore diameter of 1.5 nm. E. From the side-view of the triangular module, there are six [N—H . . . O] and six [O—H . . . N] hydrogen bonds between these 5 IATH-2 molecules, directing the formation of highly catenated structure.

FIGS. 12A-12C show the top-view (A) and side-view (B) of representative [O—H . . . O], [N—H . . . O] and [O—H . . . N] hydrogen bonds in the crystal superstructure and structural formulas (C) of four molecular fragments of IATH-1. Light dotted lines represent hydrogen bonds.

FIG. 13 shows the relative intensity of PXRD peaks at (100) planes of RP-H100 under different temperatures.

FIG. 14 shows the relative intensity of PXRD peaks at (100) planes of RP-H101 under different temperatures.

FIGS. 15A-15C show A. The H₂ adsorption isotherms for RP-H100 at 77 K, 160 K, and 296 K. B. Corresponding Van't Hoff Plot derived from (a). C. The isosteric heats of adsorption (Qₛₜ) of RP-H100 for H₂.

FIGS. 16A-16C show A. The H₂ adsorption isotherms for RP-H101 at 77 K, 160 K, and 296 K. B. Corresponding Van't Hoff Plot derived from (a). C. The isosteric heats of adsorption (Qₛₜ) of RP-H101 for H₂.

FIGS. 17A-17C show A. Initial structure of RP-H100 with the disorder. B. Non-disordered structure I (ND-I) of RP-H100 by taking the average positions of occupied carbon atoms. C. Non-disordered structure II (ND-II) of RP-H100 by choosing a particular rotation of the benzene rings.

FIGS. 18A-18C show A. DFT optimized structure of the non-disordered version of RP-H100 by taking the average positions of occupied carbon atoms (ND-I-Opt). B. DFT optimized structure of the non-disordered version of RP-H100 by choosing a particular rotation of the benzene rings (ND-II-Opt). C. DFT optimized structure of experimentally reported RP-H101 (Opt).

FIG. 19 shows experimental and simulated H₂ adsorption isotherms of RP-H100 and RP-H101. Circle, square and triangle symbols represent the uptake at 77, 160 and 296 K, respectively. Unfilled symbols with different colours to represent the simulated adsorption data for different crystal structures of RP-H100 and RP-H101.

FIGS. 20A-20C show the single-crystal structure of RP-H101. The phenylene rings that have the potential to rotate freely are shown in orange boxes. A-C The original structure (A), the DFT-optimized structure (B), and the 90°-rotated structure (C) are represented, with their corresponding simulated surface areas displayed below. The rotatable phenylene rings are indicated by orange squares.

### DETAILED DESCRIPTION OF THE INVENTION

The present disclosure provides a porous supramolecular crystal having a catenated superstructure. The porous supramolecular crystal is designed to have high volumetric and gravimetric storage capacities to efficiently use hydrogen as a fuel. In some embodiments, a catenation strategy is used to form the porous supramolecular crystal. Catenation in porous materials refers to the phenomenon where two or more independent porous networks (or frameworks) are interwoven or interlocked within the same crystal lattice without covalent bonds between them. In some embodiments, the controlled catenation strategy uses the formation of hydrogen bonds to guide catenation in a point-contact manner.

A high gravimetric surface area (GSA) requires a material to be as lightweight as possible for a given surface area. Therefore, constructing porous materials entirely from light elements is tempting when it comes to realizing high GSAs. Molecular crystals, e.g., hydrogen-bonded organic frameworks (HOFs), are assembled¹⁶ from organic molecules-generally composed of light elements, such as carbon, nitrogen and oxygen-through noncovalent interactions, e.g., hydrogen bonding and [π . . . π] stacking, have shown considerable potential for diverse applications, such as gas separation and catalysis on account of their tunable pore sizes and tailorable superstructures¹⁷. The potential for hydrogen storage in molecular crystals has not been explored in detail for the reason that it is challenging for them to achieve large surface areas and high stabilities concurrently.

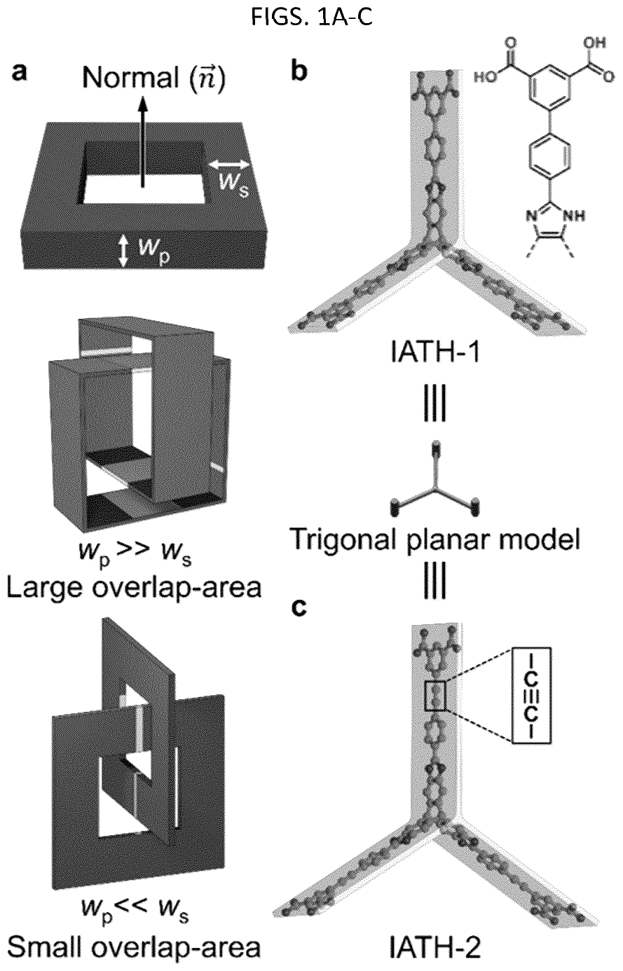

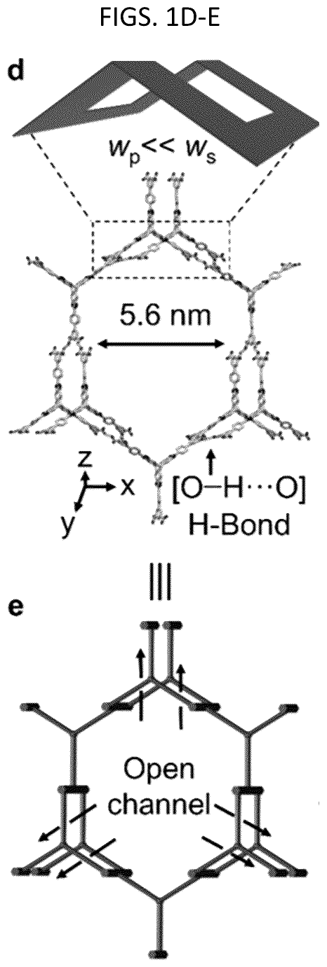

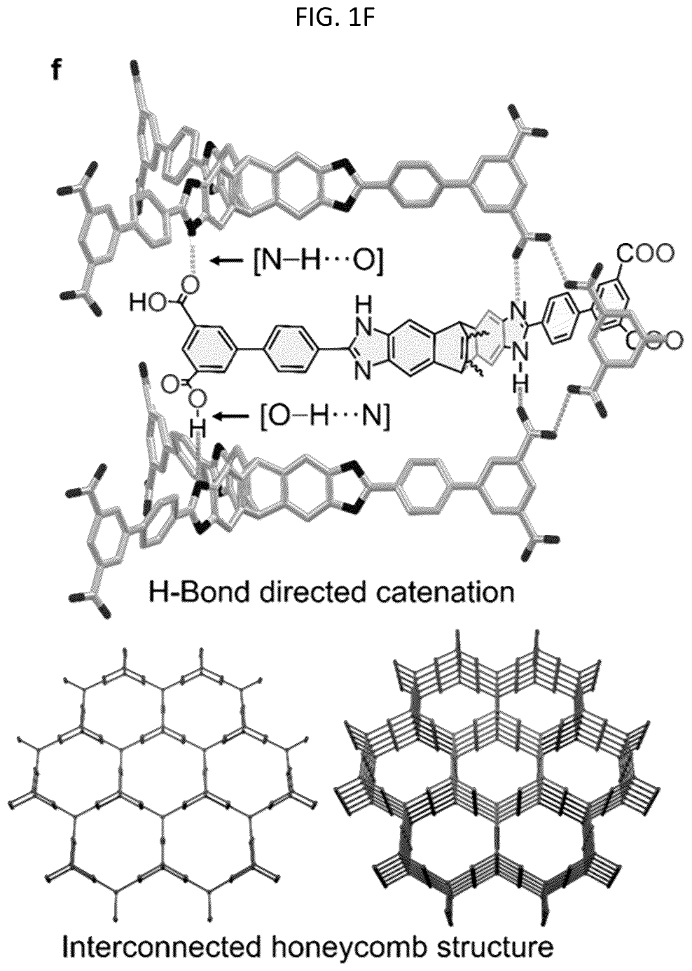

Catenation observed in porous materials, a phenomenon in which two or more networks become interpenetrated¹⁸⁻²¹. Catenation is usually associated with enhanced stability^{19,22,23}. Catenation, however, generally reduces surface areas and even results in non-porous materials because the accessible surfaces are commonly obstructed (FIG. 1A and B) by neighboring catenated components. Therefore, interpenetration in porous materials is usually considered undesirable with significant efforts to avoid it²⁴⁻²⁶. Nonetheless, if catenation can be controlled in a precise manner, i.e., avoiding the loss of accessible surface areas caused by catenation as much as possible-we hypothesized that it might be possible to obtain a robust material with both high volumetric surface area (VSA) and GSA values. It should be noted that appropriate pore diameters, critical for high-performance hydrogen storage, can also be tailored²⁷ rather precisely if catenation can be controlled and turned to advantage.

In some embodiments, the porous supramolecular crystal has a pore diameter from 1.2 nm to 1.9 nm. In some embodiments, the porous supramolecular crystal has a pore diameter of at least 1.0 nm, at least 1.1 nm, at least 1.2 nm, at least 1.3 nm, at least 1.4 nm, at least 1.5 nm, at least 1.6nm, at least 1.7 nm, at least 1.8 nm, or at least 1.9 nm. Pore diameters may be determined by methods known in the art, such as those described in the Examples.

In some embodiments, the porous supramolecular crystal has a gravimetric surface area of at least 1500 m² g⁻¹, at least 1600 m² g⁻¹, at least 1700 m² g⁻¹, at least 1800 m² g⁻¹, at least 1900 m² g⁻¹, at least 2000 m² g⁻¹, at least 2100 m² g⁻¹, at least 2200 m² g⁻¹, at least 2300 m² g⁻¹, at least 2400 m² g⁻¹, at least 2500 m² g⁻¹, at least 2600 m² g⁻¹, at least 2700 m² g⁻¹, at least 2800 m² g⁻¹, at least 2900 m² g⁻¹, at least 3000 m² g⁻¹, at least 3100 m² g⁻¹, at least 3200 m² g⁻¹, at least 3300 m² g⁻¹, at least 3400 m² g⁻¹, or at least 3500 m² g⁻¹. In some embodiments, the porous supramolecular crystal has a GSA of at least 1500 m² g⁻¹, at least 1600 m² g⁻¹, at least 1700 m² g⁻¹, at least 1800 m² g⁻¹, at least 1900 m² g⁻¹, at least 2000 m² g⁻¹, at least 2100 m² g⁻¹, at least 2200 m² g⁻¹, at least 2300 m² g⁻¹, at least 2400 m² g⁻¹, at least 2500 m² g⁻¹, at least 2600 m² g⁻¹, at least 2700 m² g⁻¹, at least 2800 m² g⁻¹, at least 2900 m² g⁻¹, at least 3000 m² g⁻¹, at least 3100 m² g⁻¹, at least 3200 m² g⁻¹, at least 3300 m² g⁻¹, at least 3400 m² g⁻¹, or at least 3500 m² g-land less than 4000 m² g⁻¹, Gravimetric surface area may be determined by methods known in the art, such as those described in the Examples.

In some specific embodiments, the porous supramolecular crystal has a VSA of at least 1500 m² cm⁻³, optionally at least 1600 m² cm⁻³, at least 1700 m² cm⁻³, or at least 1800 m² cm⁻³. In some specific embodiments, the porous supramolecular crystal has a VSA of at least 1500 m² cm⁻³, optionally at least 1600 m² cm⁻³, at least 1700 m² cm⁻³, at least 1800 m² cm⁻³, at least 1900 m² cm⁻³, at least 2000 m² cm⁻³, at least 2100 m² cm⁻³, at least 2200 m² cm⁻³, at least 2300 m² cm⁻³, at least 2400 m² cm⁻³, or at least 2500 m² cm⁻³ and less than 3000 m² cm⁻³. Volumetric surface area may be determined by methods known in the art, such as those described in the Examples.

In some embodiments, the porous supramolecular crystal has a gravimetric capacity of between 5.0 wt % and 16.0 wt %, between 6.0 wt % and 10.0 wt %, or between 6.5 wt % and 9.5 wt %. In some embodiments, the porous supramolecular crystal has a gravimetric capacity of at least 5.0 wt %, at least 6.0 wt %, at least 6.5 wt %, at least 7.0 wt %, at least 7.5 wt %, at least 8.0 wt %, at least 8.5 wt %, or at least 9.0 wt %. Gravimetric capacity may be determined by methods known in the art, such as those described in the Examples.

In some embodiments, the porous supramolecular crystal has a volumetric capacity of between 30 g L⁻¹ and 70 g L⁻¹, between 35 g L⁻¹ and 55 g L⁻¹, or between 40 g L⁻¹ and 55 g L⁻¹. In some embodiments, the porous supramolecular crystal has a volumetric capacity of at least 45 g L⁻¹, at least 46 g L⁻¹, at least 47 g L⁻¹, at least 48 g L⁻¹, at least 49 g L⁻¹, at least 50 g L⁻¹, optionally at least 51 g L⁻¹, at least 52 g L⁻¹, at least 53 g L⁻¹, or at least 54 g L⁻¹. Volumetric capacity may be determined by methods known in the art, such as those described in the Examples.

In some embodiments, the porous supramolecular crystal has a thermal stability of at least 150° C., at least 160° C., at least 170° C., at least 180° C., at least 190° C., at least 200° C., at least 210° C., at least 220° C., at least 230° C., at least 240° C., at least 250° C., at least 260° C., at least 270° C., at least 280° C., at least 290° C., at least 300° C., at least 310° C., at least 320° C., at least 330° C., at least 340° C., at least 350° C., at least 355° C., at least 360° C., at least 365° C., at least 370° C., or at least 375° C. Thermal stability may be determined by methods known in the art including those described in the Examples.

In some embodiments, the porous supramolecular crystal has a total pore volume of at least 0.8 cm³ g⁻¹, at least 0.9 cm³ g⁻¹, at least 1.00 cm³ g⁻¹, at least 1.05 cm³ g⁻¹, at least 1.10 cm³ g⁻¹, at least 1.15 cm³ g⁻¹, at least 1.20 cm³ g⁻¹, at least 1.25 cm³ g⁻¹, at least 1.30 cm³ g⁻¹, or at least 1.35 cm³ g⁻¹. In some embodiments, the porous supramolecular crystal has a total pore volume of at least 1.00 cm³ g⁻¹, at least 1.05 cm³ g⁻¹, at least 1.10 cm³ g⁻¹, at least 1.15 cm³ g⁻¹, at least 1.20 cm³ g⁻¹, at least 1.25 cm³ g⁻¹, at least 1.30 cm³ g⁻¹, at least 1.40 cm³ g⁻¹, at least 1.50 cm³ g⁻¹, at least 1.60 cm³ g⁻¹, at least 1.70 cm³ g⁻¹, at least 1.80 cm³ g⁻¹, or at least 1.90 cm³ g⁻¹, and less than 2.0 cm³ g⁻¹.

Suitably, the porous supramolecular crystal may have two or more of the afore described properties. For example, the porous supramolecular crystal may have two or more properties selected from the group selected from a pore diameter from 1.0 to 1.9 nm, a gravimetric surface area of at least 1500 m² g⁻¹, a volumetric surface area of at least 1500 m² cm⁻³, a gravimetric capacity of at least 5.0 wt %, a volumetric capacity of at least 30 g L⁻¹, a thermal stability of at least 150° C., and a total pore volume of at least 0.8 cm³ g⁻¹. In some instances, the porous supramolecular crystal has three, four, five, six, or all of these properties.

In some embodiments, the porous supramolecular crystal is formed from a triptycene. The porous supramolecular crystal may comprise D₃ₕ symmetry. In specific embodiments, the porous supramolecular crystal is formed from an imidazole-annulated triptycene hexaacid when nine molecules assemble into a secondary hexagonal superstructure containing three open channels through which seven of the hexagons interpenetrate each other, directed by hydrogen bonding interactions. In some embodiments, the porous supramolecular crystal comprises a 7-fold catenated topology. In some embodiments, the porous supramolecular crystal is prepared from IATH-1 as shown in FIG. 1B or IATH-2 as shown in FIG. 1C. In some embodiments, the porous supramolecular crystal is RP-H101 or RP-H100.

The present disclosure also provides a method for storing hydrogen, the method comprising contacting a porous supramolecular crystal as described herein with hydrogen under conditions sufficient for adsorbing hydrogen. In some embodiments, the method further comprising desorbing the hydrogen.

### Miscellaneous

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### EXAMPLES

The storage of hydrogen is key to many different and newer applications. Developing adsorbent materials¹⁻⁸ with high volumetric and gravimetric storage capacities⁹, both of which are essential for the efficient use of hydrogen as a fuel, is challenging. Herein, a controlled catenation strategy that utilizes the formation of hydrogen bonds to guide catenation in a point-contact manner is reported. It imparts high volumetric and gravimetric surface areas, along with robustness, on supramolecular crystals (e.g., RP-H100 and RP-H101). Exemplary crystals are formed from an imidazole-annulated triptycene hexaacid when nine molecules assemble into a secondary hexagonal superstructure containing three open channels through which seven of the hexagons interpenetrate each other, directed by hydrogen bonding interactions to form a 7-fold catenated superstructure, which ensures both high gravimetric and volumetric surface areas and defines pore diameters (ca. 1.2-1.9 nm) that are optimal for hydrogen storage. RP-H101 exhibits record-high volumetric deliverable hydrogen (53.7 g L⁻¹) and high gravimetric (9.3 wt %) capacities under a combined temperature and pressure swing (77 K/100 bar→160 K/5 bar).

Herein, we demonstrate a design principle that utilizes hydrogen bonding interactions instead of [π . . . π] stacking to direct and define catenation in a point-contact manner in supramolecular crystals, effectively reducing the surface loss caused by interpenetration and customizing the pore diameter desired for hydrogen storage. Based on this principle, we have obtained a HOF (RP-H101) with record-high gravimetric (3526 m² g⁻¹) and balanced volumetric (1855 m² cm⁻³) surface areas among all the reported (supra)molecular crystals, in addition to high stability, whilst (i) bringing about unprecedented material-level volumetric capacity (54.6 g L−1), (ii) balancing high gravimetric capacity (9.3 wt %) for hydrogen storage under practical pressure and temperature swing conditions (77 K/100 bar→160 K/5 bar), and (iii) surpassing the DOE ultimate system-level targets (50 g L⁻¹ and 6.5 wt %) both volumetrically and gravimetrically, albeit at cryogenic temperatures. These results demonstrate the potential for employing supramolecular crystals as candidates for hydrogen storage.

### Design of Crystals With High Surface Areas

The surface areas of porous materials originate from the portion of the framework surface that is accessible to guest molecules. Catenation decreases the GSA since the accessible surface is blocked inevitably by the act of interpenetration. In order to illustrate this failing, in the top panel of FIG. 1A defines two kinds of surfaces in each catenated component: primary ones (P) and secondary ones (S), corresponding to surfaces parallel and perpendicular, respectively, to the normal direction (\vec{n}) of the catenated components. When the width (wₚ) of the primary surfaces is much wider than that (wₛ) of the secondary surfaces, catenation leads to a significant loss of accessible surface areas because of the large surface overlap (middle panel of FIG. 1A), which is the case for most of the catenated structures reported in the literature to date. Such losses, however, can be reduced considerably when wₚ<<wₛ (bottom panel, FIG. 1A). When wₚ approaches zero, the overlap area between the two catenated components is the point at which surface losses can be avoided. It turns out that the GSA is maintained whilst the VSA rises since the number of framework atoms per unit volume is increased. Given this scenario, a higher degree of catenation in a superstructure that involves more than two catenated components can lead to a further increase in the VSA.

The analysis suggests that the geometry of the two catenated components determines largely the degree of surface loss in catenated superstructures. In order to realise minimal surface loss (i.e., wₚ <<wₛ) in catenated molecular crystals, we chose triptycene, in which three benzenoid rings are displayed with D₃ₕ symmetry (FIG. 1B), as the molecular skeleton to form a paddle-wheel structure that endows the scaffold with intrinsic porosity and rigidity at one and the same time. In order to realise directional catenation, we incorporated two types of spatially separated hydrogen-bonding motifs, i.e., two terminal carboxyl groups and one internally located imidazole ring in each wing of the skeleton. The resulting molecular building blocks, IATH-1 and IATH-2, shown in FIGS. 1B and 1C, were obtained and characterized by ¹H/¹³C NMR spectroscopies and high-resolution mass spectrometry. Note that IATH-2 is the extended version of IATH-1 on introducing one acetylenic link into each wing of IATH-1.

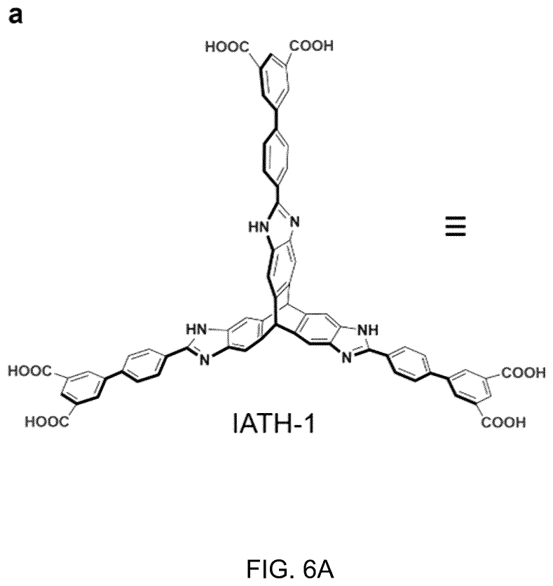

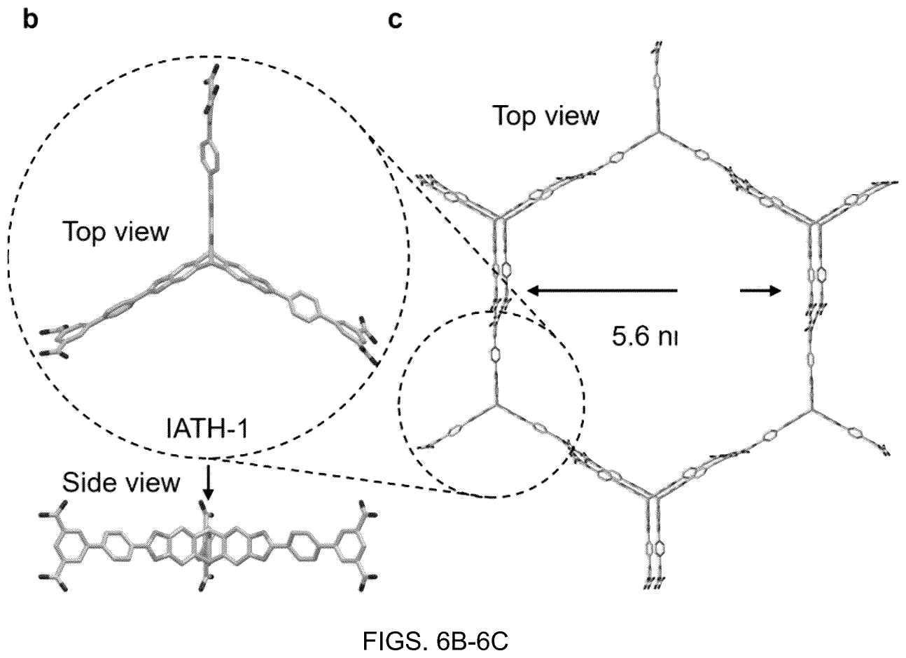

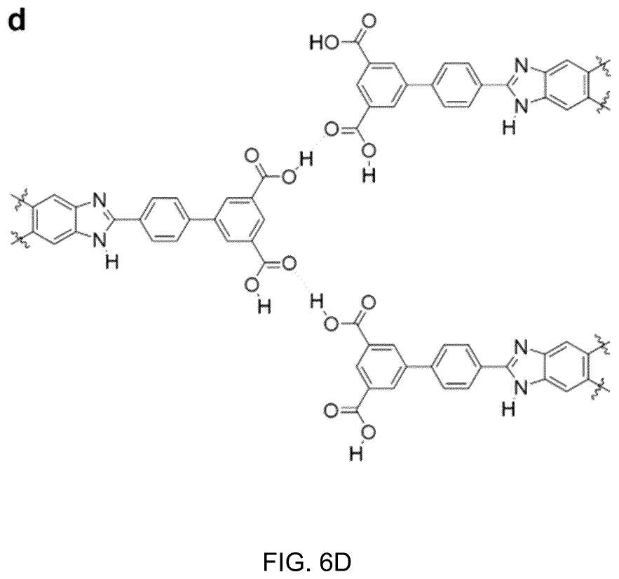

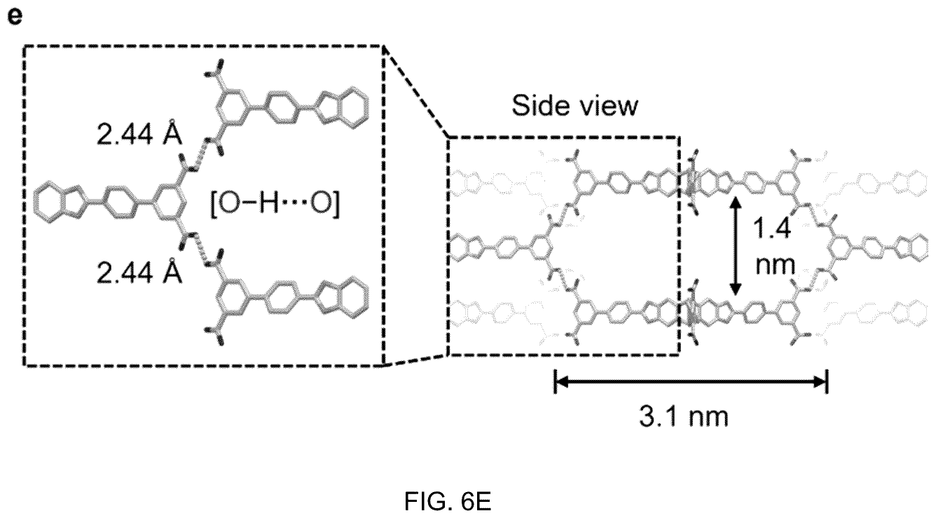

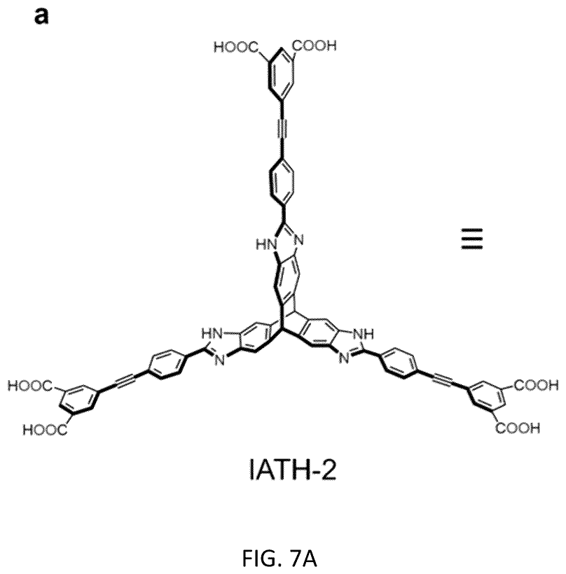

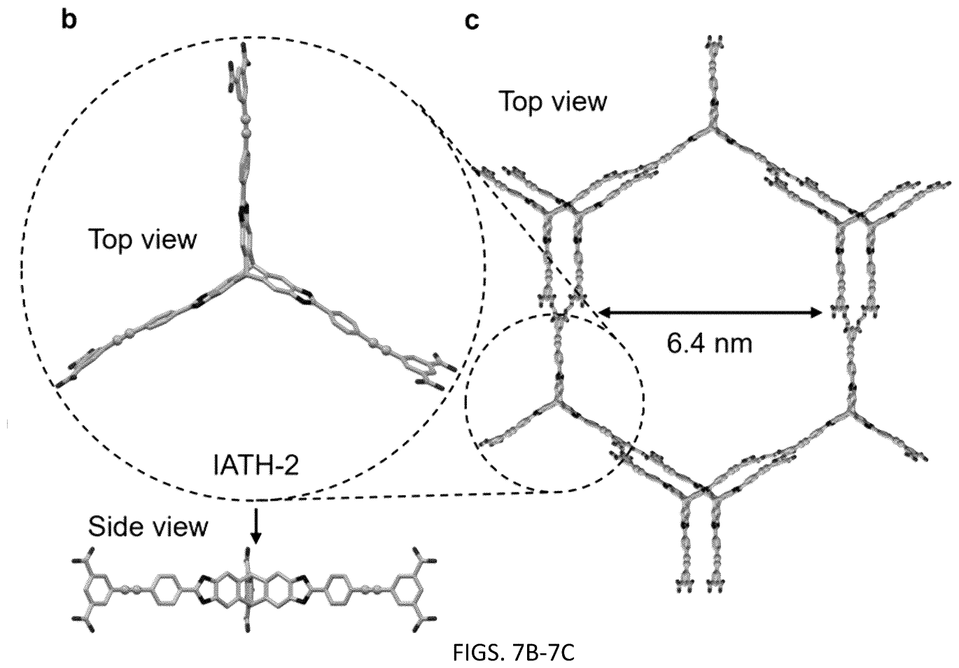

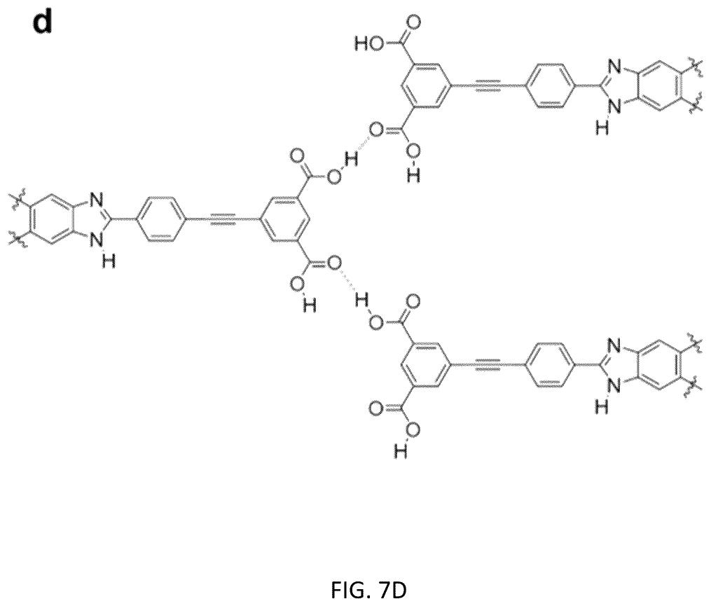

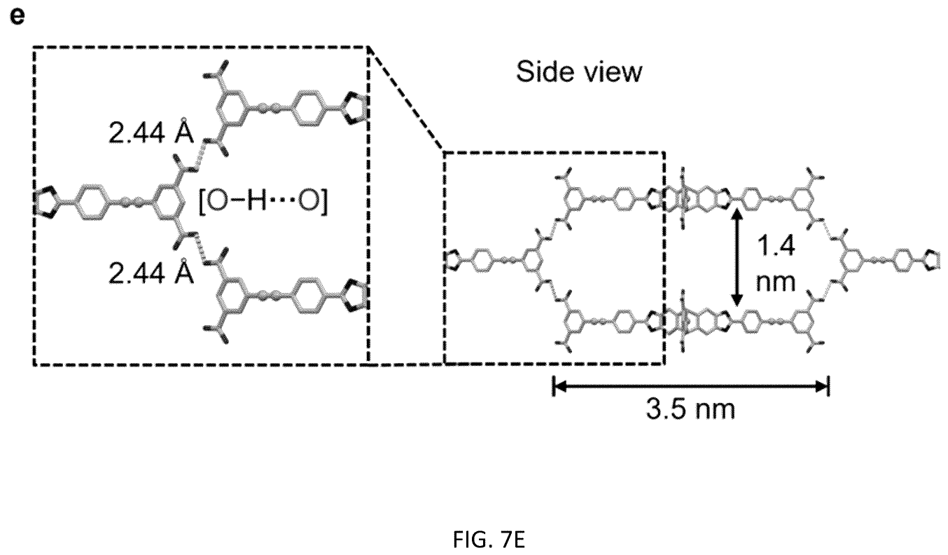

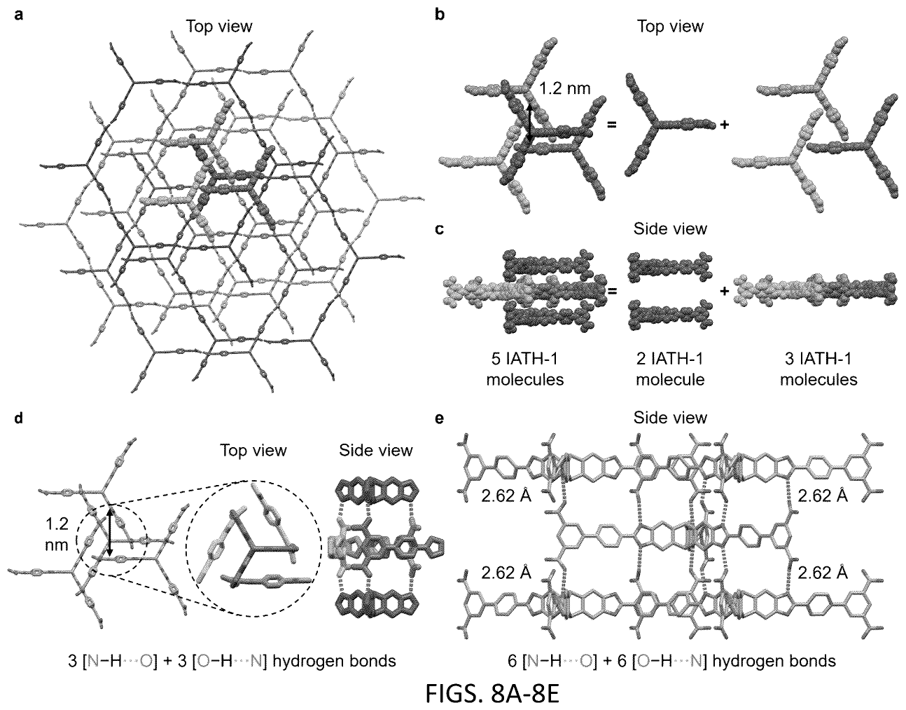

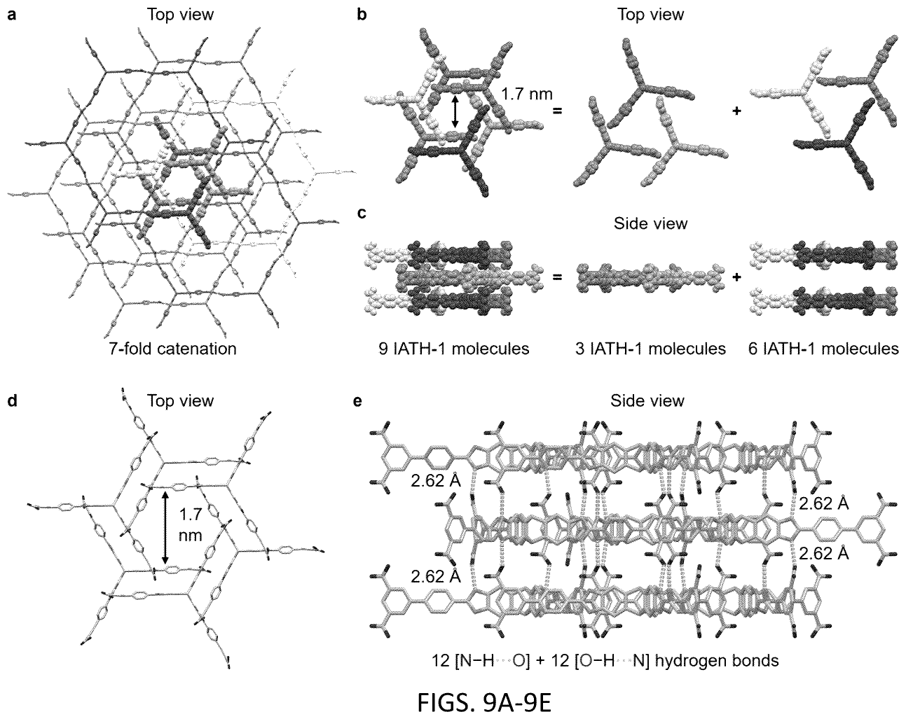

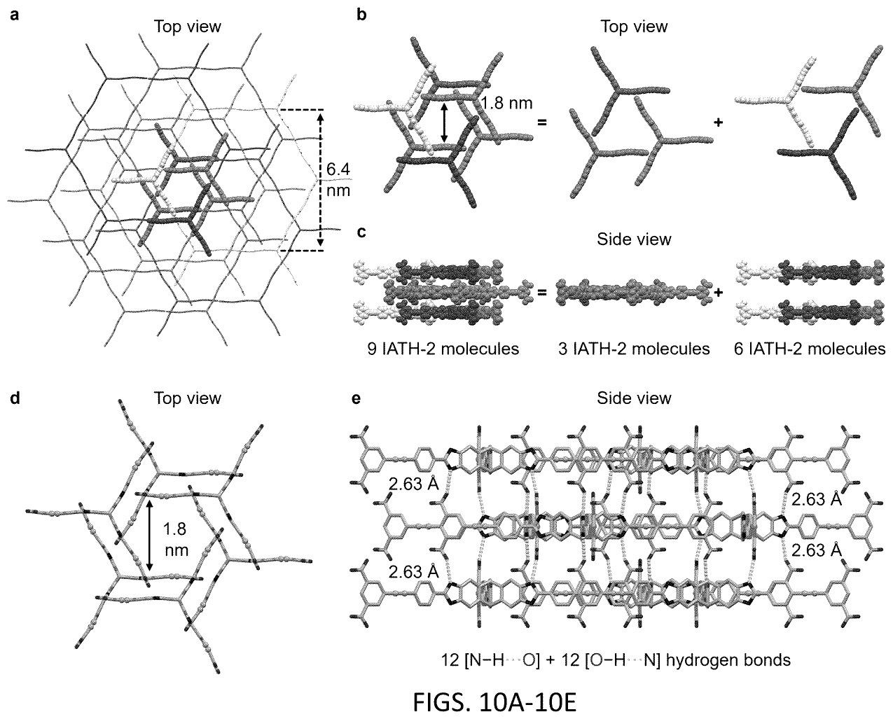

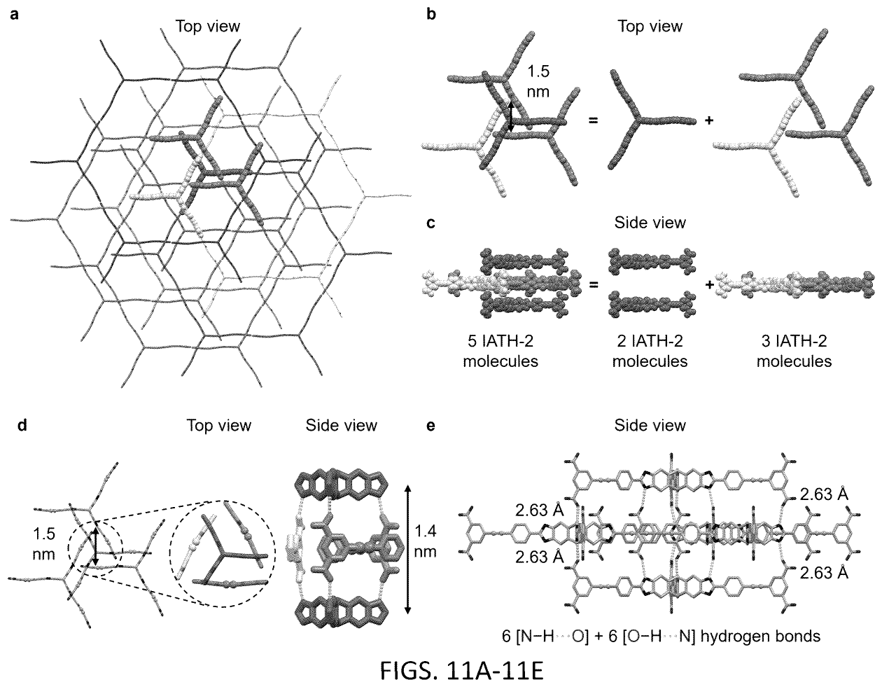

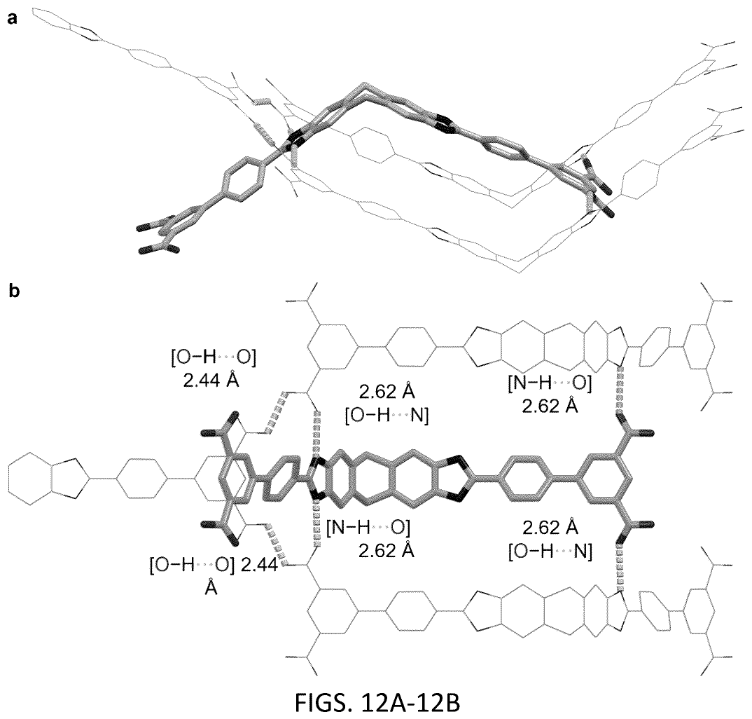

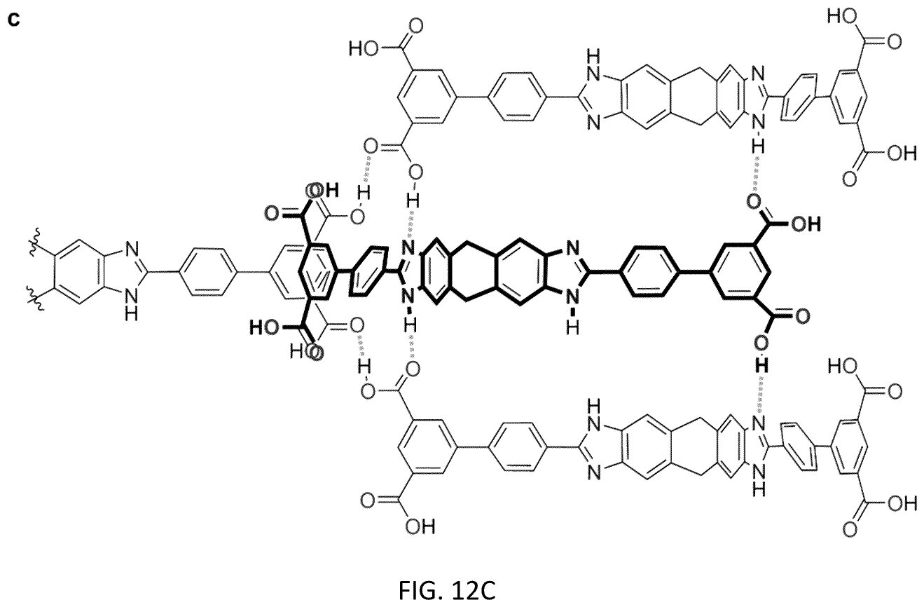

Single crystals of IATH-1 and IATH-2 can be obtained readily by dissolving them in dimethylformamide (DMF) and heating at 140° C. for 8 h, leading to highly porous frameworks, referred to as RP-H100 and RP-H101 in Tables 1 and 2, respectively. In the single-crystal superstructure of RP-H100, nine IATH-1 building blocks are connected by 12 [O—H . . . O] hydrogen bonds, forming a hexagonal motif (FIG. 1D and FIG. 6) with a diameter of 5.6 nm. RP-H101, constructed from IATH-2, is isostructural (FIG. 7) with RP-H100. In an attempt to illustrate the topological superstructures of RP-H100 and RP-H101, we have used a trigonal planar model (FIG. 1B, C) to represent the building blocks, IATH-1 and IATH-2, with nine of them forming (FIG. 1E) a simplified model of the hexagonal motif. Arrays of hexagonal motifs are connected using [O—H . . . O] hydrogen bonds in the xy-plane to form an infinite two-dimensional (2D) network that extends along the z-axis to produce 3D honeycomb-like frameworks. These frameworks are interconnected, on account of the existence of three open channels—denoted by black arrows in FIG. 1E—in the hexagonal motif. These open channels provide the basis to direct the formation of the catenated superstructure. Two supramolecular building blocks can interpenetrate (FIG. 1F) through the open channels directed by forming [N—H . . . O] and [O—H . . . N] hydrogen bonds (FIGS. 8-12). This kind of interpenetration is desirable because the wₚ of two catenated components is much smaller than wₛ (FIGS. 1A and 1D), a situation when the surface loss is expected to be the cross-sectional areas of hydrogen bonds (point contacts), instead of [π . . . π] stacking (surface contacts).

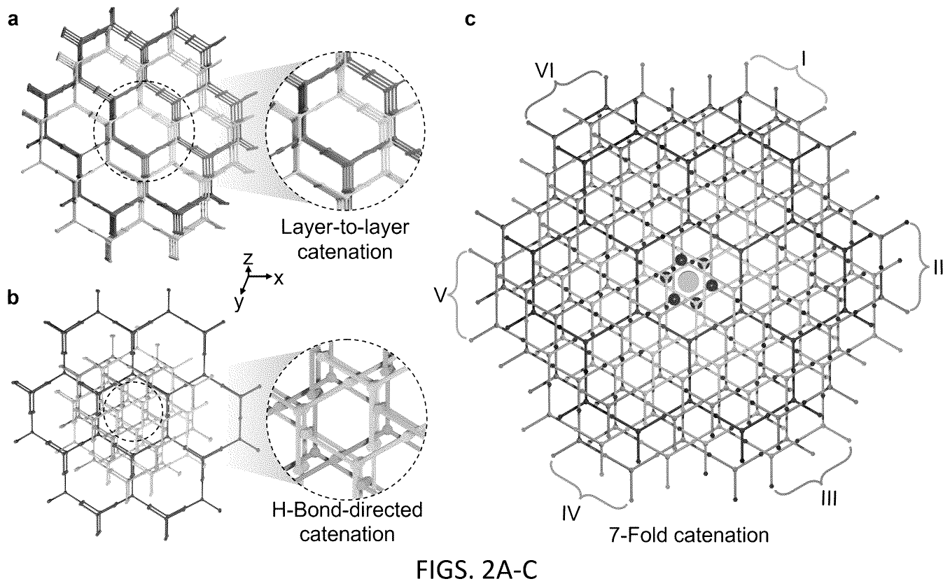

The extension of this kind of interpenetration leads (FIG. 2A) to two supramolecular frameworks interpenetrated through the open channels. Within one layer, each hexagonal motif is interpenetrated (FIG. 2B) with another six to form highly catenated superstructures. Such interpenetration modes are extended infinitely in the xy-plane, forming (FIG. 2C) a 7-fold catenated topology. The other six layered components interlocked are denoted in different labels from I to VI. It is worth noting that all the intermolecular interactions within the crystal superstructure are hydrogen bonds, which is beneficial for reducing surface loss. Catenation is also responsible for tailoring the pore geometries and diameters. The 7-fold catenation generates a hierarchical superstructure with two kinds of pores in the crystals, i.e., a triangular prismatic cavity and 1D channels. Based on single-crystal superstructures, the pore diameters in RP-H100 are 1.2 nm and 1.7 nm, whilst those (FIGS. 8-11) in RP-H101 are 1.5 and 1.8 nm, which are significantly reduced compared to the pore diameters of the secondary hexagon (FIG. 1D). According to previous computational predictions²⁸ focusing on MOFs, these pore diameters are within the ideal range for high-performance hydrogen storage.

### Stability and Porosity

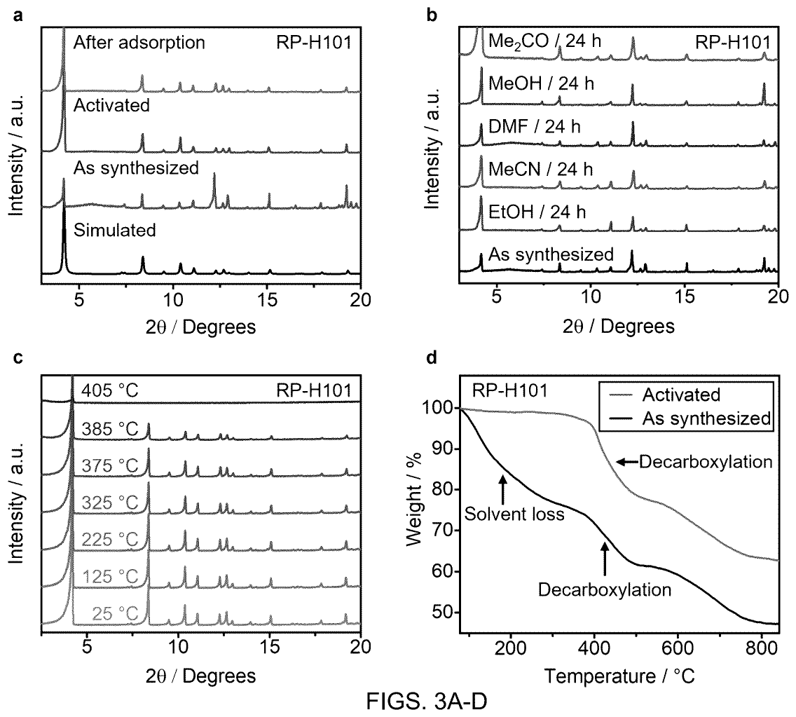

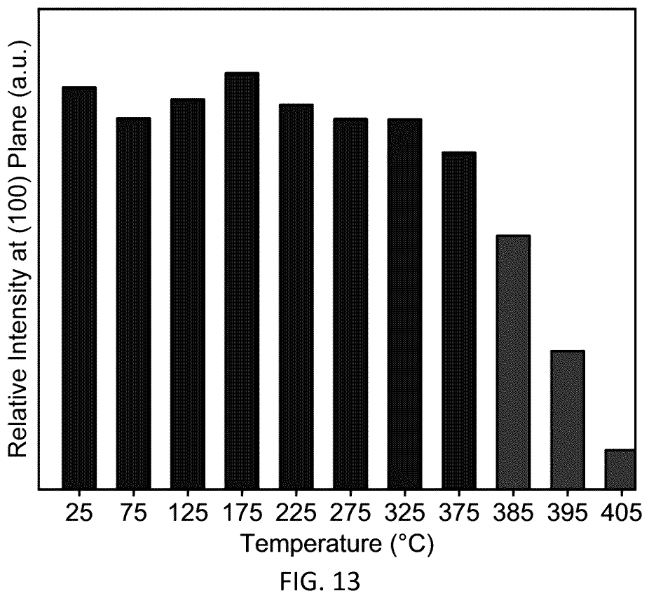

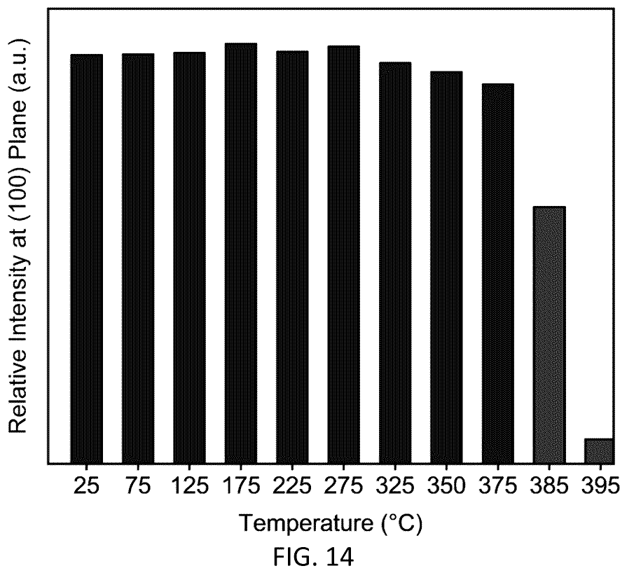

The 7-fold catenation endows RP-H100 and RP-H101 with high stabilities. The PXRD patterns (FIG. 3A) of as-synthesized and activated RP-H100 and RP-H101 frameworks agree well with the simulated patterns from the single-crystal superstructures, demonstrating their robustness during solvent removal. The solvent stability of porous materials is critical for their potential applications. RP-H100 and RP-H101 resist (FIG. 3B) most of the commonly used organic solvents, such as ethanol (EtOH), acetone (Me₂CO), and DMF. After soaking the as-synthesized crystals in these solvents for 24 h, their PXRD patterns were well-maintained. The thermal stabilities of RP-H100 and RP-H101 were evaluated by variable-temperature PXRD (VT-PXRD). The VT-PXRD patterns and peak intensities for RP-H100 exhibit (FIG. 13) almost no change up until 375° C., indicating the retention of good crystallinity. RP-H101 with higher porosity, shows (FIG. 3C and FIG. 14) almost the same thermal stability as RP-H100. Thermogravimetric analyses (TGA) of both RP-H100 and RP-H101 exhibit (FIG. 3D) a mass loss starting at around 380° C., associated with the decomposition of the frameworks. The thermal stabilities of RP-H100 and RP-H101 arc comparable²⁹ with the most robust MOFs.

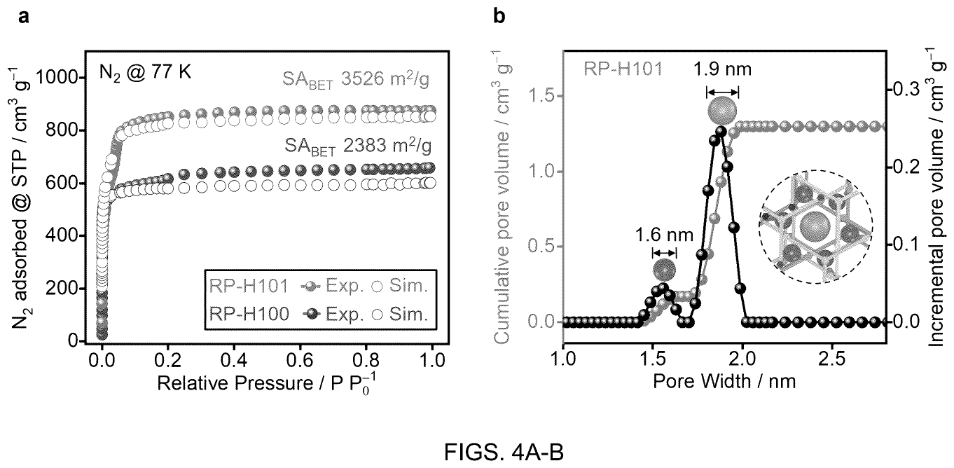

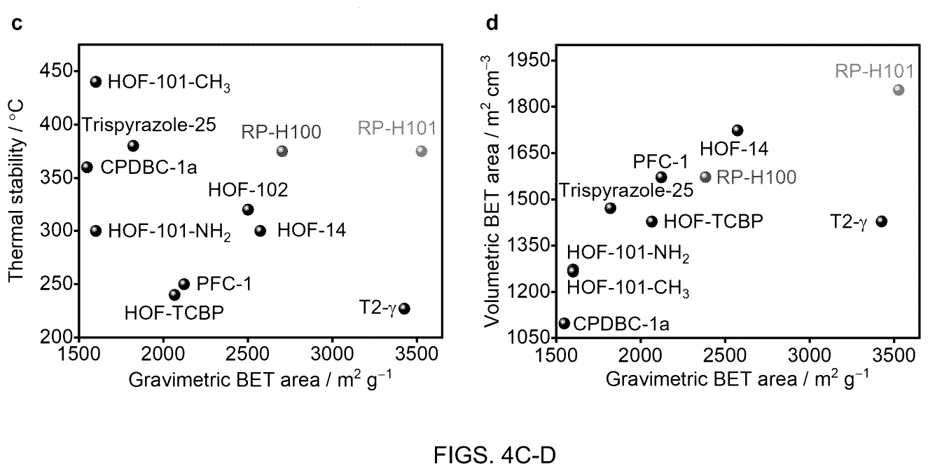

The permanent porosity of RP-H100 and RP-H101 following supercritical CO₂ activation has been confirmed by N₂ adsorption isotherms recorded at 77 K. These isotherms show typical type I sorption behaviour (FIG. 4A), in keeping with the microporous nature of RP-H100 and RP-H101. The Brunauer-Emmett-Teller (BET) surface areas, calculated using the updated Rouquerol criteria implemented software BETSI³⁰, deduced from the N₂ isotherms of RP-H100 and RP-H101, arc 2383 and 3526 m² g⁻¹, respectively. The experimental BET surface areas of RP-H100 and RP-H101 agree well with the theoretical values of 2034 and 3345 m² g⁻¹, respectively, calculated using Zeo++³¹. The volumetric BET areas of RP-H100 and RP-H101, calculated based on the crystallographic densities, are 1573 and 1855 m² cm⁻³, respectively. It should be noted that the volumetric performance may be affected by different methods of densification and powder packing³². The pore size distributions of RP-H100 and RP-H101, derived from the N₂ isotherms at 77 K using non-local density functional theory (NLDFT)³³, reveal two kinds of pores with diameters of around 1.2 and 1.7 nm for RP-H100 and 1.6 and 1.9 nm for RP-H101 (FIG. 4B), corresponding to the triangular prism-shaped pores (spheres) and hexagonal channels (pillars) based on their single-crystal superstructures. The total pore volumes of RP-H100 and RP-H101 are, respectively, 1.11 and 1.35 cm³ g⁻¹, volumes which agree well with the simulated values (1.03 and 1.42 cm³ g⁻¹) obtained from their single-crystal superstructures. Owing to the hydrogen-bond reinforced-catenated superstructures, RP-H100 and RP-H101 both exhibit (FIG. 4C) high thermal stabilities and large surface areas, suggesting that a high degree of catenation directed by hydrogen bonding is beneficial for the construction of supramolecular frameworks with robust permanent porosities. Although 7-fold catenation endows RP-H101 with a density as high as 0.526 g cm⁻³, it exhibits the largest experimental GSA obtained for HOFs as of now^{34,35}, bringing about (FIG. 4D and Table 3) uncommonly balanced high GSA (3526 m² g⁻¹) and VSA (1855 m² cm 3) in keeping with the effective taming of surface losses by the directional catenation strategies. Moreover, these surface areas are within the optimal range for hydrogen storage predicted²⁸ by theoretical calculations.

### Hydrogen Storage Performance

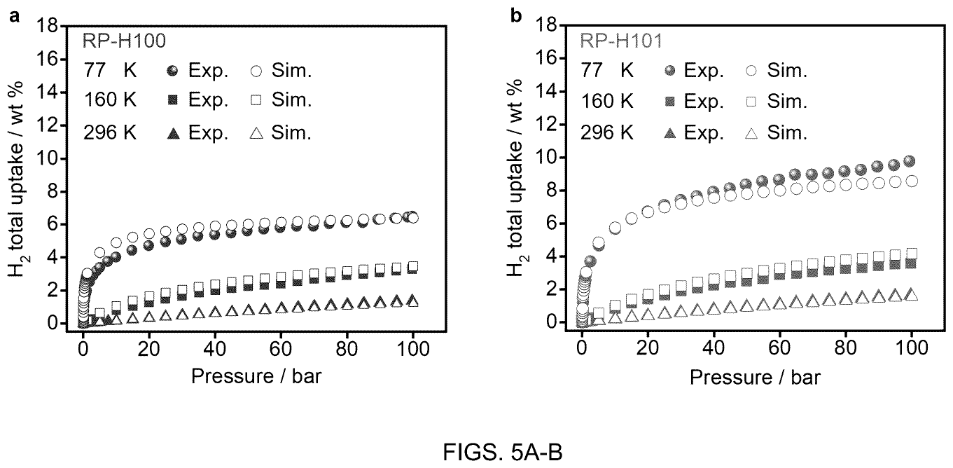

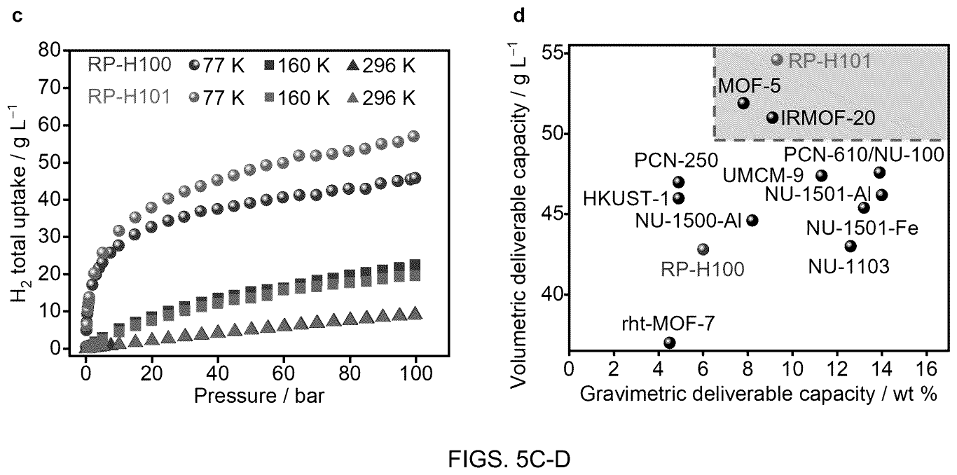

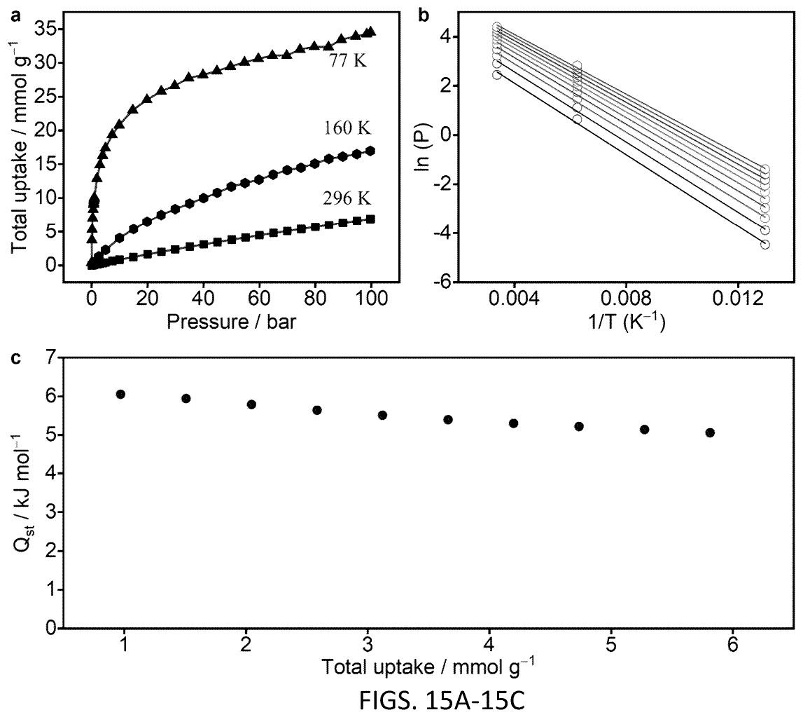

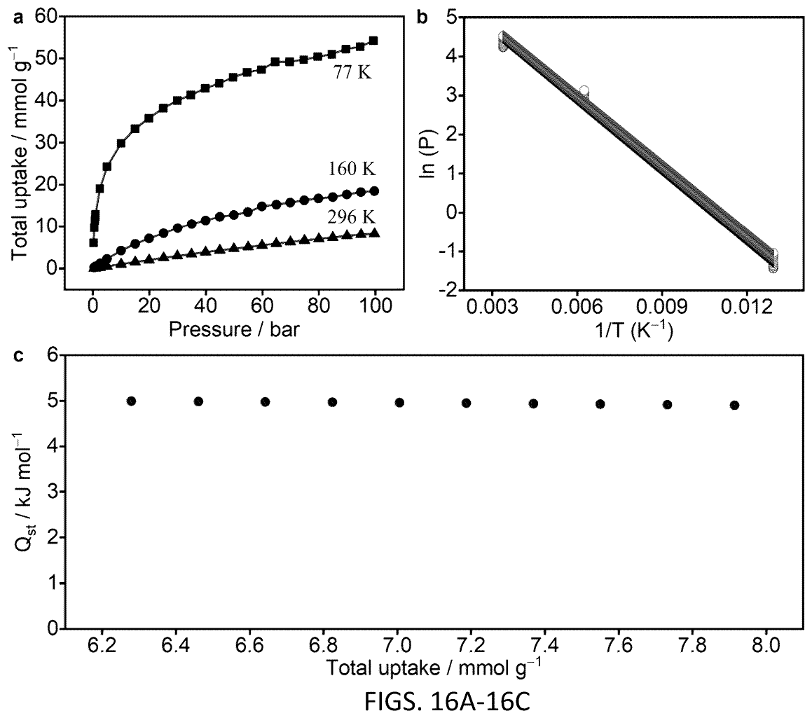

The robustness and high surface areas of both RP-H100 and RP-H101 encouraged us to investigate their hydrogen-storage performance under practical operating conditions. For H₂ used in fuel-cell vehicles, the minimum inlet pressure delivering hydrogen to the engine is 5 bar, making the H₂ adsorbed below 5 bar unusable. The deliverable capacity, the amount of stored fuel that can be delivered to the engine under practical operation conditions, is critical³⁶. The deliverable capacity of hydrogen under 77 K/100 bar→160 K/5 bar, an operable condition for hydrogen storage systems, has received¹¹ extensive attention. The total capacity (FIG. 5A and 5C) of hydrogen in RP-H100 is 6.5 wt % (45.8 g L⁻¹) at 77 K/100 bar with a deliverable capacity of 6.0 wt % (42.8 g L⁻¹) under combined temperature and pressure-swing conditions (77 K/100 bar→160 K/5 bar). The extended framework of RP-H101 shows a significantly enhanced total uptake of hydrogen (FIGS. 5B and 5C), which is 9.7±0.2 wt % (56.5±1.1 g L⁻¹) at 77 K/100 bar. The simulated isotherm at 77 K and above 40 bar is slightly lower than the experimental isotherm, possibly because of the slight discrepancy in the conformation of IATH-2 between the simulated and experimental structures. The gravimetric and volumetric deliverable capacities of RP-H101 are, respectively, 9.3±0.2 wt % and 53.7±1.0 g L⁻¹. These material-level deliverable capacities of RP-H101, albeit at cryogenic temperatures, exceed the DOE system-level gravimetric targets (6.5 wt %) by 43% and surpass the volumetric targets (50 g L⁻¹) by 7.4%. Notably, the volumetric deliverable capacity represents the highest value among reported porous materials (FIG. 5D and Table 4). The high adsorption capacity of hydrogen in RP-H100 and RP-H101 is associated with the moderate isosteric heats of adsorption (Qₛₜ) obtained from isotherms (FIGS. 15 and 16) at different temperatures. At room temperature (296 K), the volumetric deliverable capacities (100 bar→5 bar) of RP-H100 and RP-H101 are 8.6 and 8.2 g L⁻¹, respectively, which are close to the reported³⁷⁻³⁹ record (11.0 g L⁻¹, 100 bar→5 bar pressure swing at 298 K) in Ni₂(m-dobdc) with open metal sites.

### Summary and Outlook

We have introduced a hydrogen-bond-directed catenation strategy for constructing highly porous supramolecular crystals in which a 7-fold catenated superstructure directed by point-contactinteractions associated with hydrogen bonds imparts the crystals with both high volumetric and large gravimetric surface areas, enhanced structural robustness, and tailored pore diameters (ca. 1.2-1.9 nm) for hydrogen storage. In particular, RP-H101 exhibits the record-high gravimetric (3526 m² g⁻¹) and balanced volumetric (1855 m² cm⁻³) surface areas together with high stability in comparison³⁴ with all molecular crystals to date, leading to a record-high deliverable volumetric capacity (54.6 g L⁻¹) whilst balancing a high gravimetric capacity (9.3 wt %) for hydrogen storage under practical operating conditions. This research demonstrates the potential of supramolecular crystals as promising candidates for onboard hydrogen storage and highlights the potential of a directional catenation strategy in designing robust porous materials with balanced high volumetric and gravimetric surface areas for applications.

### References for Background, Description, and Examples

1. Rosi, N. L. et al. Hydrogen storage in microporous metal-organic frameworks. Science 300, 1127-1129 (2003).
2. Murray, L. J., Dincă, M. & Long, J. R. Hydrogen storage in metal-organic frameworks. Chem. Soc. Rev. 38, 1294-1314 (2009).
3. Sculley, J., Yuan, D. & Zhou, H.-C. The current status of hydrogen storage in metal-organic frameworks—updated. Energ. Environ. Sci. 4, 2721-2735 (2011).
4. Cote, A. P. et al. Porous, crystalline, covalent organic frameworks. Science 310, 1166-1170 (2005).
5. Han, S. S., Furukawa, H., Yaghi, O. M. & Goddard, W. A., III. Covalent organic frameworks as exceptional hydrogen storage materials. J. Am. Chem. Soc. 130, 11580-11581 (2008).
6. Furukawa, H. & Yaghi, O. M. Storage of hydrogen, methane, and carbon dioxide in highly porous covalent organic frameworks for clean energy applications. J. Am. Chem. Soc. 131, 8875-8883 (2009).
7. Yuan, D., Lu, W., Zhao, D. & Zhou, H.-C. Highly stable porous polymer networks with exceptionally high gas-uptake capacities. Adv. Mater. 23, 3723-3725 (2011).
8. Ben, T. et al. Targeted synthesis of a porous aromatic framework with high stability and exceptionally high surface area. Angew. Chem. Int. Ed. 48, 9457-9460 (2009).
9. Ahmed, A. et al. Balancing gravimetric and volumetric hydrogen density in MOFs. Energ. Environ. Sci. 10, 2459-2471 (2017).
10. U.S. Department of Energy. Target explanation document: Onboard hydrogen storage for light-duty fuel cell vehicles, Hydrogen and Fuel Cell Technologies Office (2014). https://www.energy.gov/eere/fuelcells/downloads/target-explanation-document-onboard-hydrogen-storage-light-duty-fuel-cell.
11. Chen, Z. et al. Balancing volumetric and gravimetric uptake in highly porous materials for clean energy. Science 368, 297-303 (2020).
12. Yang, S. et al. Cation-induced kinetic trapping and enhanced hydrogen adsorption in a modulated anionic metal-organic framework. Nat. Chem. 1, 487-493 (2009).
13. Liu, S. et al. Hydrogen storage in incompletely etched multilayer Ti2CTx at room temperature. Nat. Nanotechol. 16, 331-336 (2021).
14. Kökçam-Demir, Ü. et al. Coordinatively unsaturated metal sites (open metal sites) in metal-organic frameworks: design and applications. Chem. Soc. Rev. 49, 2751-2798 (2020).
15. Sengupta, D. et al. Air-stable Cu (I) metal-organic Framework for hydrogen storage. J. Am. Chem. Soc. 145, 20492-20502 (2023).
16. Vantomme, G. & Meijer, E. W. The construction of supramolecular systems. Science 363, 1396-1397 (2019).
17. Lin, R.-B. & Chen, B. Hydrogen-bonded organic frameworks: Chemistry and functions. Chem 8, 2114-2135 (2022).
18. Batten, S. R. & Robson, R. Interpenetrating nets: Ordered, periodic entanglement. Angew. Chem. Int. Ed. 37, 1460-1494 (1998).
19. Chen, B., Eddaoudi, M., Hyde, S. T., O'Keeffe, M. & Yaghi, O. M. Interwoven metal-organic framework on a periodic minimal surface with extra-large pores. Science 291, 1021-1023 (2001).
20. Meng, W. et al. An elastic metal-organic crystal with a densely catenated backbone. Nature 598, 298-303 (2021).
21. Perl, D., Lee, S. J., Ferguson, A., Jameson, G. B. & Telfer, S. G. Hetero-interpenetrated metal-organic frameworks. Nat. Chem. 15, 1358-1364 (2023).
22. Wang, B., Lin, R.-B., Zhang, Z., Xiang, S. & Chen, B. Hydrogen-bonded organic frameworks as a tunable platform for functional materials. J. Am. Chem. Soc. 142, 14399-14416 (2020).
23. Ma, S. et al. Framework-catenation isomerism in metal-organic frameworks and its impact on hydrogen uptake. J. Am. Chem. Soc. 129, 1858-1859 (2007).
24. Shekhah, O. et al. Controlling interpenetration in metal-organic frameworks by liquid-phase epitaxy. Nat. Mater. 8, 481-484 (2009).
25. Zhang, J., Wojtas, L., Larsen, R. W., Eddaoudi, M. & Zaworotko, M. J. Temperature and concentration control over interpenetration in a metal-organic material. J. Am. Chem. Soc. 131, 17040-17041 (2009).
26. Farha, O. K., Malliakas, C. D., Kanatzidis, M. G. & Hupp, J. T. Control over catenation in metal-organic frameworks via rational design of the organic building block. J. Am. Chem. Soc. 132, 950-952 (2010).
27. Maji, T. K., Matsuda, R. & Kitagawa, S. A flexible interpenetrating coordination framework with a bimodal porous functionality. Nat. Mater. 6, 142-148 (2007).
28. Bobbitt, N. S., Chen, J. & Snurr, R. Q. High-throughput screening of metal-organic frameworks for hydrogen storage at cryogenic temperature. J. Phys. Chem. C 120, 27328-27341 (2016).
29. Healy, C. et al. The thermal stability of metal-organic frameworks. Coord. Chem. Rev. 419, 213388 (2020).
30. Osterrieth, J. W. M. et al. How reproducible are surface areas calculated from the BET equation? Adv. Mater. 34, 2201502 (2022).
31. Willems, T. F., Rycroft, C. H., Kazi, M., Meza, J. C. & Haranczyk, M. Algorithms and tools for high-throughput geometry-based analysis of crystalline porous materials. Microporous Mesoporous Mater. 149, 134-141 (2012).
32. Suresh, K. et al. Optimizing hydrogen storage in MOFs through engineering of crystal morphology and control of crystal size. J. Am. Chem. Soc. 143, 10727-10734 (2021).
33. Jagiello, J. & Jaroniec, M. 2D-NLDFT adsorption models for porous oxides with corrugated cylindrical pores. J. Colloid Interface Sci. 532, 588-597 (2018).
34. Pulido, A. et al. Functional materials discovery using energy-structure-function maps. Nature 543, 657-664 (2017).
35. Zhang, G., Presly, O., White, F., Oppel, I. M. & Mastalerz, M. A permanent mesoporous organic cage with an exceptionally high surface area. Angew. Chem. Int. Ed. 53, 1516-1520 (2014).
36. Rozyyev, V. et al. High-capacity methane storage in flexible alkane-linked porous aromatic network polymers. Nat. Energy 4, 604-611 (2019).
37. Allendorf, M. D. et al. Challenges to developing materials for the transport and storage of hydrogen. Nat. Chem. 14, 1214-1223 (2022).
38. Kapelewski, M. T. et al. M2 (m-dobdc) (M=Mg, Mn, Fe, Co, Ni) metal-organic frameworks exhibiting increased charge density and enhanced H2 binding at the open metal sites. J. Am. Chem. Soc. 136, 12119-12129 (2014).
39. Kapelewski, M. T. et al. Record high hydrogen storage capacity in the metal-organic framework Ni2(m-dobdc) at near-ambient temperatures. Chem. Mater. 30, 8179-8189 (2018).

### Section 1. Materials and General Methods

All reagents were sourced from commercial suppliers (Sigma-Aldrich, AmBeed, Combi-Blocks, or Fisher) and were used with no further purification. Thin layer chromatography (TLC) was conducted on silica gel 60 F254 (E. Merck). Normal-phase column chromatography (RediSep Rf Gold® Normal-Phase Silica) was carried out using CombiFlash® Automation Systems (Teledyne ISCO). High-resolution mass spectra were collected on an Agilent 6230 Time-of-Flight (TOF) Mass Spectrometer with an electrospray ionization (ESI) source, attached to an Agilent 1200 series HPLC stack. Data were acquired with Agilent Mass Hunter Acquisition software and analysed with Agilent Mass Hunter Qualitative Analysis software. Nuclear magnetic resonance (NMR) spectra were recorded at room temperature on a Bruker Avance III 500 MHz system equipped with a DCH CryoProbe and working frequencies of 500 MHz for ¹H and 126 MHz for ¹³C nuclei, respectively. Chemical shifts are reported in parts per million (ppm) and are referenced to the residual protic-solvent (CDCl₃: δ_{H}=7.26 ppm, δ_{C}=77.36 ppm; (CD₃)₂SO: δ_{H}=2.54 ppm, δ_{C}=40.45 ppm). NMR Spectra were analysed with MestraNova software (Version 12.0). Data are represented as follows: chemical shift, multiplicity (s=singlet, d=doublet, t=triplet, q=quartet, bs=broad singlet, m=multiplet), coupling constants in Hertz (Hz), and integration.

### Section 2. Synthetic Protocols

### 2.1 Synthesis of IATH-1

R1: Dimethyl 5-iodoisophthalate (1.0 g, 3.1 mmol), 4-formylphenylboronic acid (0.47 g, 3.1 mmol), Pd(PPh₃)₄ (35.8 mg, 31 μmol) and 1,4-dioxane (12 mL) were added to a 50-mL round-bottomed flask with a magnetic stirrer bar equipped. Then, the tightly sealed setup was degassed and refilled with N₂ three times, after which K₃PO₄ (3 mL, 1 M) was added. The reaction was stirred at 100° C. for 12 h. After cooling to room temperature, the aqueous

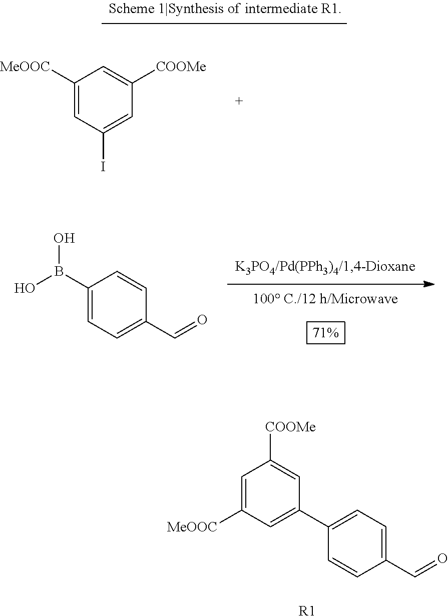

layer at the bottom of the flask was removed by pipette before evaporating 1,4-dioxane under reduced pressure. The residue was purified by normal-phase chromatography (70% CH₂Cl₂ in EtOAc) to give the product R1 (0.66 g, 71%) as a white solid. ¹H NMR (500 MHz, CDCl₃): δ 10.09 (s, 1H), 8.72 (s, 1H), 8.51 (d, J=1.6 Hz, 2H), 8.01 (d, J=8.3 Hz, 2H), 7.84 (d, J=8.3 Hz, 2H), 4.00 (s, 6H). ¹³C NMR (126 MHz, CDCl₃): δ 192.2, 166.3, 145.2, 140.8, 136.2, 132.8, 131.8, 130.8, 130.7, 128.2, 53.0.
Me₆IATH-1:2,3,6,7,14,15-Hexaaminotriptycene hexahydrochloride (R3) was synthesized using a previously reported¹ procedure. R1 (0.80 g, 2.68 mmol), R3 (0.50 g, 0.89 mmol),

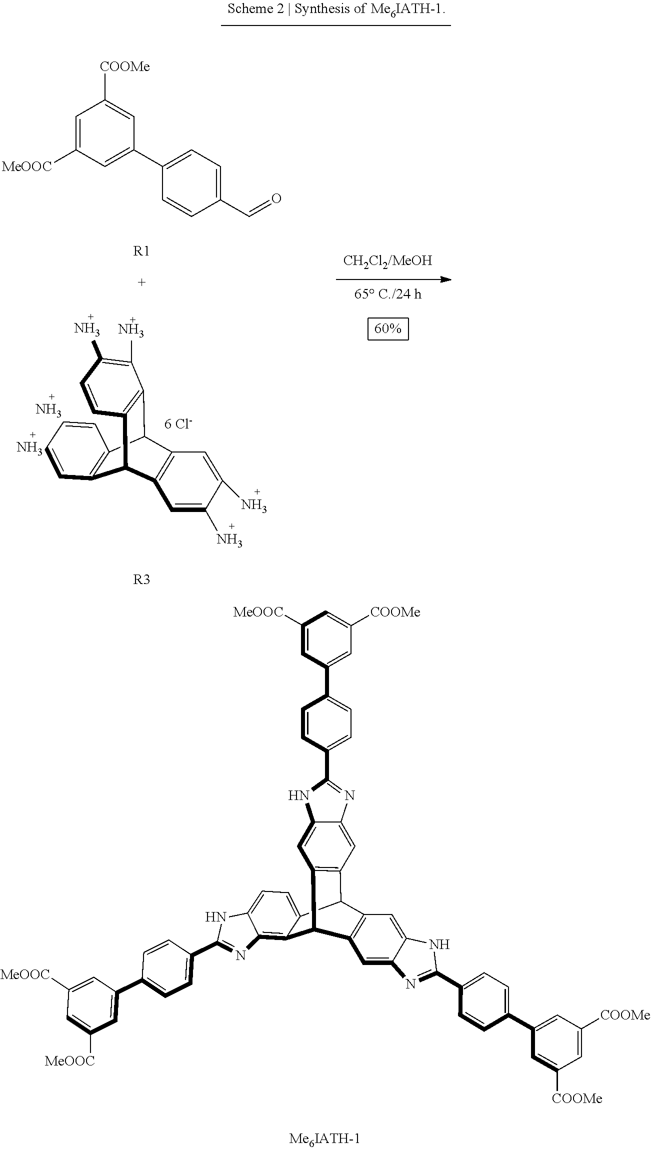

CH₂Cl₂ (10 mL) and MeOH (55 mL) were added to a 100 mL round-bottomed flask equipped with a magnetic stirrer bar. The setup was then stirred at 65° C. whilst open to air for 24 h. After cooling to room temperature, the solvent of the residue was removed under vacuum, and the collected precipitates were purified by chromatography (10% MeOH in CH₂Cl₂) to give the product Me₆IATH-1 (0.63 g, 60%) as a red-brown powder. ¹H NMR (500 Mhz, (CD₃)₂SO): δ 8.54 (d, J=15.0 Hz, 9H), 8.44 (d, J=8.1 Hz, 6H), 8.14 (d, J=8.0 Hz, 6H), 8.00 (s, 6H), 6.35 (s, 2H), 3.97 (s, 18H). ¹³C NMR (126 Mhz, (CD₃)₂SO): δ 165.8, 149.3, 142.5, 141.6, 140.5, 132.2, 131.7, 129.7, 128.7, 128.6, 125.7, 110.5, 53.3, 52.7. HR-ESI-MS (m/z): calculated for [C₇₁H₅₁N₆O₁₂]⁺ 1179.3559, found 1179.3601.

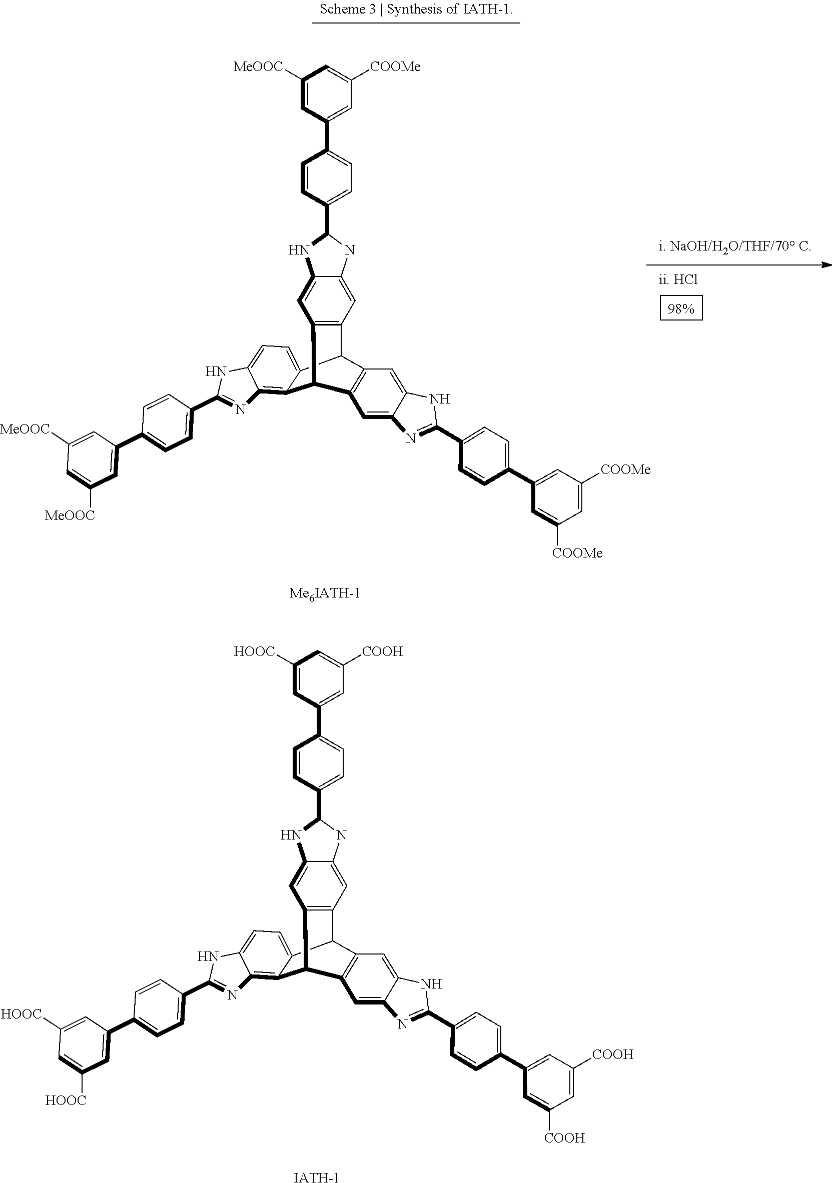

IATH-1: Me₆IATH-1 (0.63 g, 0.53 mmol) was dissolved in THF (20 mL) and NaOH (20 mL, 1M) in a 100-mL round-bottomed flask with a magnetic stirrer bar. The mixture was stirred at 70° C. overnight. After cooling to room temperature, THF was removed under reduced pressure and the remaining solution was then acidified with HCl aqueous solution (12 mL, 2 M). The resulting dark pink precipitate was collected by vacuum filtration, washed with H₂O (10 mL×5), CH₂Cl₂, and dried under reduced pressure. The final product is a reddish-brown solid (0.57 g, 98%). ¹H NMR (500 Mhz, (CD₃)₂SO): δ 8.51 (d, J=6.0 Hz, 9H), 8.30 (d, J=7.9 Hz, 6H), 8.00 (d, J=7.9 Hz, 6H), 7.79 (s, 6H), 5.98 (s, 2H). ¹³C NMR (126 Mhz, (CD₃)₂SO): δ 167.5, 151.2, 141.8, 141.7, 141.2, 140.3, 133.2, 132.2, 130.3, 130.2, 128.5, 128.1, 111.3, 53.9. HR-ESI-MS (m/z): calculated for [C₆₅H₃₉N₆O₁₂]⁺ 1095.2620, found 1095.2627.

### 2.2 Synthesis of IATH-2

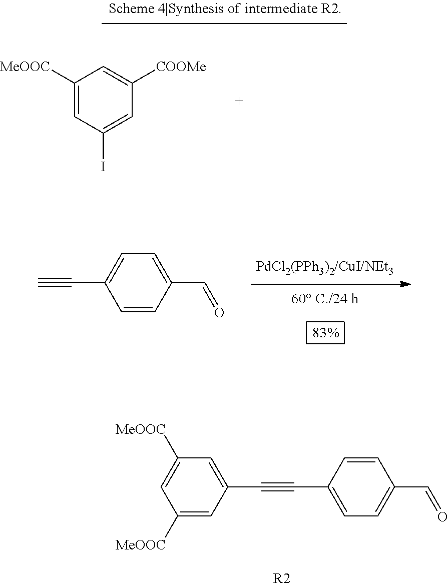

R2: Dimethyl 5-iodoisophthalate (2.58 g, 8.06 mmol), 4-ethynylbenzaldehyde (1 g, 7.68 mmol), Pd(PPh₃)₂Cl₂ (53.9 mg, 76.8 μmol) and Et₃N (23.5 mL) were added to a 50-mL round-bottomed flask with a magnetic stirrer bar equipped. Then, the tightly sealed setup was degassed and refilled with N₂ three times, after which Cul (29.3 mg, 153.6 μmol) was added. The reaction was stirred at 60° C. for 24 h. After cooling to room temperature, the mixture was diluted with EtOAc and washed with brine. The organic layer was dried with MgSO₄. The solvent of the residue was removed under vacuum and purified by chromatography (49% CH₂Cl₂ in hexane) to give the product R2 (2.01 g, 83%) as a light-yellow powder. ¹H NMR (500 MHz, CDCl₃) δ 10.04 (s, 1H), 8.66 (s, 1H), 8.40 (d, J=1.7 Hz, 2H), 7.90 (d, J=8.3 Hz, 2H), 7.70 (d, J=8.3 Hz, 2H), 3.98 (s, 6H).¹³C NMR (126 Mhz, CDCl₃) δ 191.8, 165.8, 137.0, 136.1, 132.6, 131.4, 131.0, 130.0, 129.0, 123.9, 91.4, 90.5, 53.0.
Me₆IATH-2: R2 (0.86 g, 2.66 mmol), R3 (0.50 g, 0.89 mmol), CH₂Cl₂ (50 mL) and MeOH (150 mL) were added to a 250-mL round-bottomed flask equipped with a magnetic stirrer bar. The setup was stirred at 65° C. for 24 h. After cooling to room temperature, the solvent of the residue was removed under vacuum and purified by chromatography (6% MeOH in CHCl₃) to give the product (0.71 g, 64%) as a red-brown powder. ¹H NMR (500 Mhz, (CD₃)₂SO) δ 12.98 (s, 3H), 8.47 (t, J=1.6 Hz, 3H), 8.34 (d, J=1.6 Hz, 6H), 8.20 (d, J=8.1 Hz, 6H), 7.81 (d, J=8.1 Hz, 6H), 7.75 (s, 6H), 5.90 (s, 2H), 3.95 (s, 18H). ¹³C NMR (126 MHz, (CD₃)₂SO) δ 165.7, 151.1, 142.2, 141.1, 136.8, 133.3, 132.0, 131.7, 130.3, 127.3, 124.6, 123.2, 114.9, 107.9, 92.2, 89.6, 53.9, 53.8. HR-ESI-MS (m/z): calculated for [C₇₇H₅₁N₆O₁₂]⁺ 1251.3559, found 1251.3558.

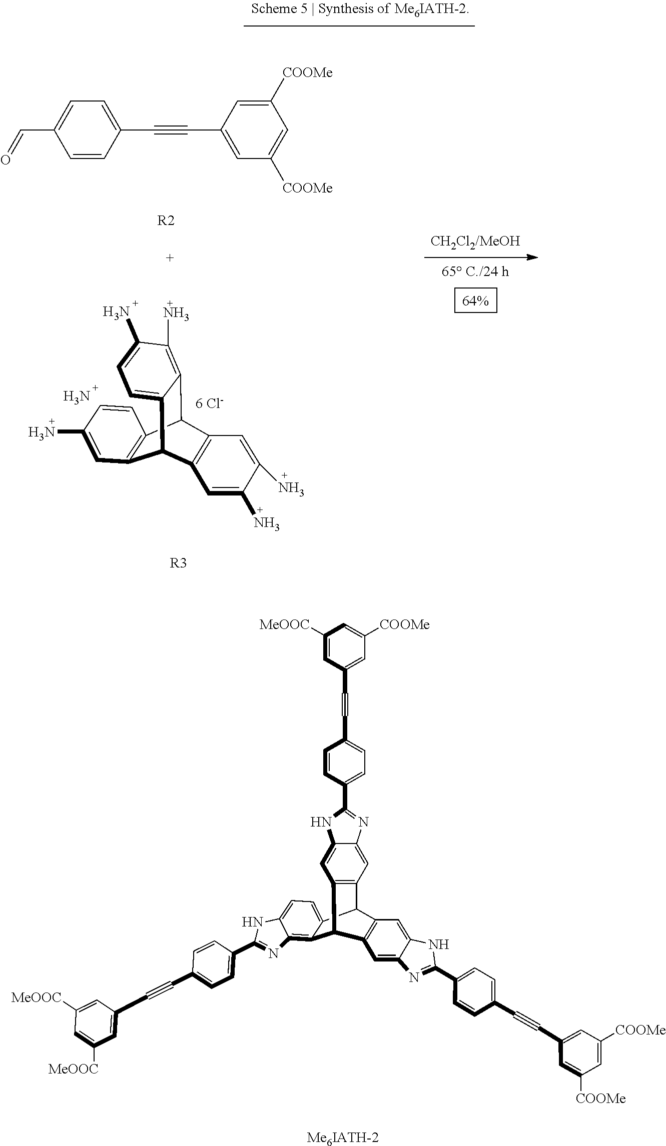

IATH-2: Me₆IATH-2 (0.71 g, 0.57 mmol) was dissolved in THF (25 mL) and NaOH (25 mL, 1 M) in a 100-mL round-bottomed flask with a magnetic stirrer bar. The mixture was stirred at 70° C. overnight. After cooling to room temperature, THF was removed under reduced pressure and the remaining solution was then acidified with HCl aqueous solution (15 mL, 2 M). The resulting precipitate was collected by vacuum filtration, washed with H₂O (10 mL×5), and CH₂Cl₂ (10 mL×2), and dried under reduced pressure. The final product, IATH-2, is a brownish-yellow solid (0.66 g, 99%). ¹H NMR (500 Mhz, (CD₃)₂SO) δ 8.49 (s, 3H), 8.31 (s, 6H), 8.22 (d, J=8.1 Hz, 6H), 7.83 (d, J=8.1 Hz, 6H), 7.78 (s, 6H), 5.97 (s, 2H). ¹³C NMR (126 Mhz, (CD₃)₂SO) δ 166.9, 150.9, 141.8, 136.7, 133.3, 133.1, 130.9, 127.5, 124.2, 123.8, 111.4, 91.7, 90.2, 53.8. HR-ESI-MS (m/z): calculated for [C₇₁H₃₉N₆O₁₂]⁺ 1167.2620, found 1167.2636.

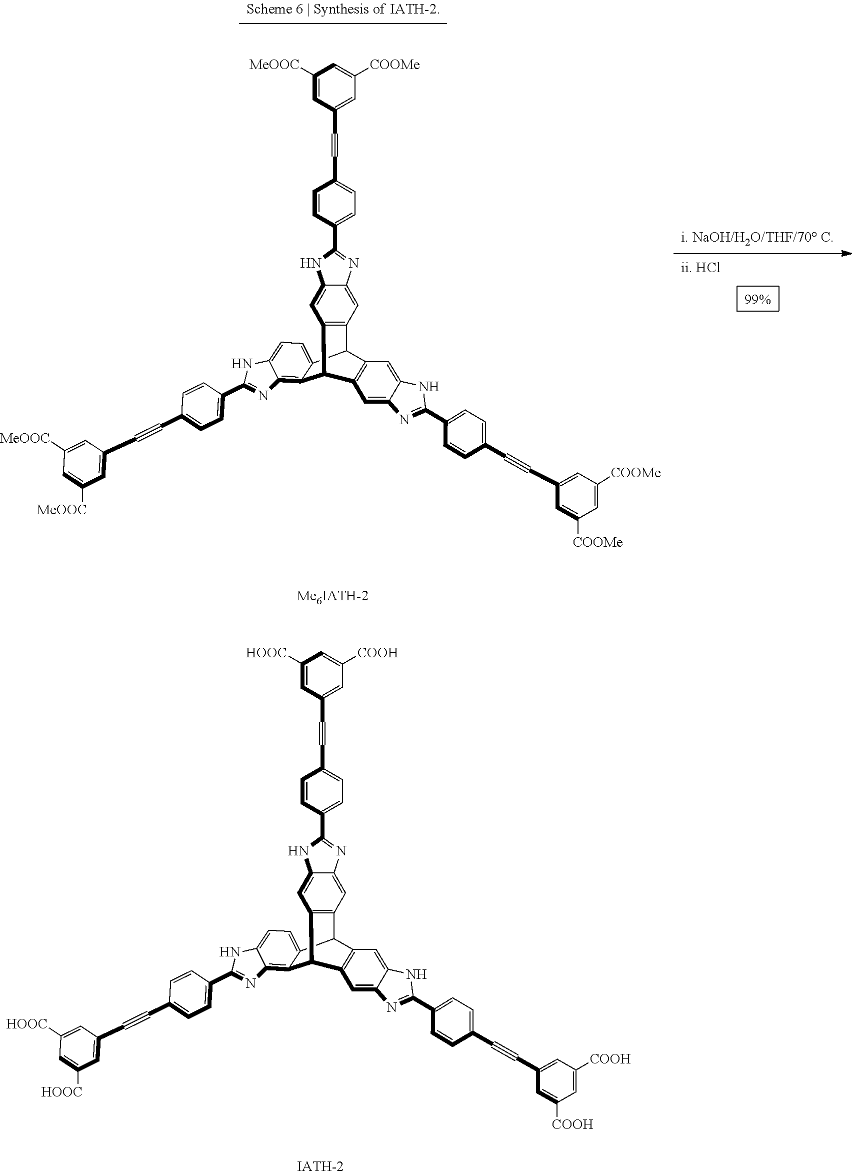

### Section 3. Single-Crystal X-Ray Diffraction Analyses

### 3.1 RP-H100

Crystallization procedure of RP-H100. IATH-1 (120 mg) was added to the mixture of N, N-dimethylformamide (DMF, 10 mL) and acetic acid (10 mL) in a borosilicate glass vial (55 mL). The mixture was then sonicated for 20 min. The resultant mixture was tightly sealed and heated at 140° C. for 8 h.
Data collection procedure of RP-H100. A suitable crystal was selected and mounted on a MITIGEN holder in paratone oil on an XtaLAB Synergy R, DW system, HyPix diffractometer. The crystal was kept at 100.0(2) K during data collection. Using Olex2², the structure was solved with the XT² structure solution program using Intrinsic Phasing and refined with the XL³ refinement package using Least Squares minimisation.
Crystal Data for RP-H100, C₆₅H₃₈N₆O₁₂ (M=1095.01): hexagonal, space group P6₃/m (no. 176), a=b=21.0282(5), c=14.3809(2) Å, V=5507.1(3) Å³, Z=2, T=100.0(2) K, μ(Cu Kα)=0.383 mm⁻¹, D_{calc}=0.660 g cm⁻³, 25191 reflections measured (4.852≤2Θ≤156.892), 4038 unique (Rᵢₙₜ=0.0386, R_{sigma}=0.0258) which were used in all calculations. The final R₁ was 0.0586 (I>2σ(I)) and wR₂ was 0.1986 (all data).
Refinement Details of RP-H100. The crystal under investigation was found to be pseudo-merohedrally twinned. The exact twin matrix identified was found to be (−1.0, 0.0, 0.0, 1.0, 1.0, 0.0, 0.0, 0.0, −1.0). The twin fraction was refined to a value of 0.1166(13).
Solvent Treatment Details of RP-H100. Diffuse, disordered solvent molecules could not be adequately modelled. The bypass procedure in Platon (Spek, 2015) was used to remove the electronic contribution from these solvents. The total potential solvent accessible void volume was 3312 Å3 and the electron count/cell=930. As the exact solvent content is not known, the reported formula reflects only the atoms used in the refinement.
The crystallographic data are available from the Cambridge Crystallographic Data Centre (CCDC) via www.ccdc.cam.ac.uk/data_request/cif. The CCDC number is 2298776.
Responses to B-level alerts for RP-H100. The B-level alert—PLAT420_ALERT_2_B D-H Bond Without Acceptor O1—H1—may come from the disorder of the H1 atom, which is difficult to locate precisely by X-ray diffraction.

TABLE 1
Crystal data and structure refinement for RP-H100.

| Empirical formula | C₆₅H₃₈N₆O₁₂ |
|---|---|
| Formula weight | 1095.01 |
| Temperature/K | 100.0(2) |
| Crystal system | hexagonal |
| Space group | P6₃/m |
| a/Å, b/Å, c/Å | 21.0282(5), 21.0282(5), 14.3809(2) |
| α/°, β/°, γ/° | 90, 90, 120 |
| Volume/Å³ | 5507.1(3) |
| Z | 2 |
| ρ_{calc}/g cm⁻³ | 0.660 |
| μ/mm⁻¹ | 0.383 |
| F(000) | 1132 |
| Crystal size/mm³ | 0.292 × 0.034 × 0.014 |
| 2Θ range for data collection | 4.852 to 156.892° |
| Index ranges | −25 ≤ h ≤ 20, −26 ≤ |
| | k ≤ 26, −12 ≤ l ≤ 18 |
| Reflections collected | 25191 |
| Independent reflections | 4038[R(int) = 0.0386] |
| Data/restraints/parameters | 4038/0/155 |
| Goodness-of-fit on F² | 1.072 |
| Final R indexes [I > 2σ (I)] | R₁= 0.0586, wR₂ = 0.1903 |
| Final R indexes [all data] | R₁= 0.0669, wR₂ = 0.1986 |
| Largest diff peak/hole/e Å⁻³ | 0.320/−0.229 |

### 3.2 RP-H101

Crystallization procedure of RP-H101. IATH-2 (128 mg) was dissolved in the mixture of DMF (10 mL) and acetic acid (20 mL) in a borosilicate glass vial (74 mL). The mixture was then sonicated for 20 min. The resultant mixture was tightly sealed and heated at 140° C. for 8 h.
Data collection procedure of RP-H101. A suitable crystal was selected and mounted on a MITIGEN holder in paratone oil on an XtaLAB Synergy R, DW system, HyPix diffractometer. The crystal was kept at 100.0 (2) K during data collection. Using Olex2², the structure was solved with the XM³ structure solution program using Dual Space and refined with the XL³ refinement package using Least Squares minimisation.
Crystal Data for RP-H101, C₇₁H₃₈N₆O₁₂ (M=1167.07): hexagonal, space group P6₃/m (no. 176), a=b=24.3030(5), c=14.4039(3) Å, V=7367.7(3) Å³, Z=2, T=100.0(2) K, μ(Cu Kα)=0.301 mm⁻¹, D_{calc}=0.526 g cm⁻³, 97228 reflections measured (7.274 ≤2Θ≤ 156.278), 5371 unique (Rᵢₙₜ =0.0483, R_{sigma}=0.0169) which were used in all calculations. The final R₁ was 0.1551 (I>2σ(I)) and wR₂ was 0.4397 (all data).
Refinement Details of RP-H101. No special refinement is necessary.
Solvent Treatment Details of RP-H101. The solvent masking procedure as implemented in Olex2 was used to remove the electronic contribution of solvent molecules from the refinement. As the exact solvent content is not known, only the atoms used in the refinement model are reported in the formula here. Total solvent accessible volume/cell=5293.3 Å³ [71.8%] Total electron count/cell=790.8.
Responses to B alerts for RP-H101. The B alert—PLAT084_ALERT_3_B High wR2 Value (i.e. >0.25) . . . 0.43—may come from the high disorder of the molecular backbone.
The B alert—PLAT420_ALERT_2_B D-H Bond Without Acceptor O2—H2—may come from the disorder of H2 atom, which is difficult to precisely locate by X-ray diffraction.

TABLE 2
Crystal data and structure refinement for RP-H101.

| Empirical formula | C₇₁H₃₈N₆O₁₂ |
|---|---|
| Formula weight | 1167.07 |
| Temperature/K | 100.0(2) |
| Crystal system | hexagonal |
| Space group | P6₃/m |
| a/Å, b/Å, c/Å | 24.3030(5), 24.3030(5), 14.4039(3) |
| α/°, β/°, γ/° | 90, 90, 120 |
| Volume/Å³ | 7367.7(3) |
| Z | 2 |
| ρ_{calc}/g cm⁻³ | 0.526 |
| μ/mm⁻¹ | 0.301 |
| F(000) | 1204 |
| Crystal size/mm³ | 0.322 × 0.213 × 0.134 |
| 2Θ range for data collection | 7.274 to 156.278° |
| Index ranges | −30 ≤ h ≤ 30, −30 ≤ |
| | k ≤ 30,−16 ≤ l ≤ 17 |
| Reflections collected | 97053 |
| Independent reflections | 5361[R(int) = 0.0483] |
| Data/restraints/parameters | 5361/0/145 |
| Goodness-of-fit on F² | 1.745 |
| Final R indexes [I > 2σ (I)] | R₁ = 0.1537, wR₂ = 0.4054 |
| Final R indexes [all data] | R₁ = 0.1671, wR₂ = 0.4271 |
| Largest diff peak/hole/e Å⁻³ | 0.65/−0.47 |

The crystallographic data are available from the Cambridge Crystallographic Data Centre (CCDC) via www.ccdc.cam.ac.uk/data_request/cif. The CCDC number is 2298777.

### Section 4. Powder X-Ray Diffraction Analyses

PXRD Data were collected at room temperature on a STOE-STADI-P powder diffractometer equipped with an asymmetrically curved Germanium monochromator (CuKα1 radiation, λ=1.54056 Å) and one-dimensional silicon strip detector (MYTHEN2 1K from DECTRIS). The line-focused Cu X-ray tube was operated at 40 kV and 40 mA. The powder was packed in a 3-mm metallic mask and sandwiched between two polyimide layers of tape. Intensity data from 2 to 20 degrees two thetas were collected over 15 mins. The instrument was calibrated against a NIST Silicon standard (640d) before the measurement.
The simulated PXRD patterns of RP-H100 and RP-H101 were calculated from the single crystal structure using the Mercury software.
Variable temperature PXRD (VT-PXRD) data were collected at room temperature on a STOE-STADI-MP powder diffractometer equipped with an asymmetrically curved Germanium monochromator (CuKα1 radiation, A=1.54056 Å) and one-dimensional silicon strip detector (MYTHEN2 1K from DECTRIS). The line-focused Cu X-ray tube was operated at 40 kV and 40 mA. The as-received powder was packed in a 0.8 mm borosilicate capillary and placed into the furnace. Temperature stability is typically 0.1° C. Intensity data from 1 to 20 degrees two thetas were collected over 10 mins. The instrument was calibrated against a NIST Silicon standard (640d) before the measurement.

### Section 5. Thermogravimetric Analyses

Thermogravimetric analyses were performed in a Netzsch STA 449 F3 Jupiter Simultaneous Thermal Analysis (STA) instrument. Crystalline materials (8˜15 mg) were placed in an alumina crucible with a weight of 207.618 mg. The sample was measured under ultra-high purity helium gas (50 mL/min). The buoyancy effect for He was corrected by measuring the empty crucible under the same measurement conditions used for the samples. The temperature was increased at a rate of 10° C./min and gases were transferred to a GC/MS on a heated (250° C.) transfer line. An Agilent Technologies 7890A GC system, equipped with a non-polar capillary column (Agilent J&B HP-5 packed with (5%-phenyl)-methylpolysiloxane) coupled to a 5975 MSD spectrometer, was used for the analyses of the gases released from the samples. A gas injection was triggered every 10 mins from the beginning of the heating cycle, and 0.25 mL of gas was sampled from the gases released by the compound and carrier gas (He). Mass spectra were scanned in the range of 10-400 u. The performance of the thermo-balance of the STA was verified by using a certified sample of calcium oxalate monohydrate (European Pharmacopoeia Reference Standard) up to 1000° C.

### Section 6. Nitrogen and Hydrogen Sorption Measurements

Supercritical CO₂ activation of RP-H100 was conducted on a Tousimis Samdri PVT-30 critical point dryer. Before performing the sc-CO₂ drying, the synthesized crystals were centrifuged to remove the supernatant. The remaining crystals were soaked in DMF for 2 days. The DMF solvent was refreshed every 12 h. For each refreshment of DMF, the DMF was removed by centrifuge and then fresh DMF (4 mL) was added into the tube. After 2 days, the DMF was centrifuged and removed. The remaining crystals were soaked in MeCN for another 3 days to exchange completely the remaining DMF. During the solvent exchange period, MeCN was removed every 12 h. The fresh MeCN was added to the vial. After removing most of the MeCN, the crystalline materials were then transferred into a glass container for sc-CO₂ activation. After sc-CO₂ activation, the sample was transferred to a sorption tube under open air and then degassed at 90° C. for 2 h and 140° C. for 12 h.
For the sc-CO₂ activation of RP-H101, the same procedures were used. The only difference is that after DMF exchange, EtOH was used for the solvent exchange of RP-H101.
N₂ sorption isotherms were measured on an ASAP 2020 (Micromeritics) instrument at Northwestern University. To improve the reproducibility of Brunauer-Emmett-Teller (BET) surface area determination, the updated Rouquerol criteria implemented software BETSI⁴ was used to calculate the BET areas of RP-H100 and RP-H101. The pore size distribution was analysed from N₂ isotherms at 77 K using a carbon cylinder-pore model.

TABLE 3
| The porosity and thermal stability for HOFs from reported literature⁵.

| | GSA | VSA | Density | Thermal Stability | |
|---|---|---|---|---|---|
| Materials | (m² g⁻¹) | (m² g⁻¹) | (g cm⁻³)^{b} | (° C.) | Ref. |
| PFC-1/HOF-101 | 2122 | 1572 | 0.741 | 250 | ⁶ |
| HOF-101-NH₂ | 1600 | 1272 | 0.795 | 300 | ⁷ |
| HOF-14 | 2573 | 1724 | 0.670 | 300 | ⁸ |
| HOF-102 | 2500 | / | / | 320 | ⁹ |
| Trispyrazole-25 | 1821 | 1471 | 0.808 | 380 | ¹⁰ |
| HOF-101-CH₃ | 1600 | 1266 | 0.791 | 440 | ⁷ |
| CPDBC-1a | 1548 | 1098 | 0.709 | 360 | ¹¹ |
| HOF-TCBP | 2066 | 1428 | 0.691 | 240 | ¹² |
| TTBI | 2796 | 2167 | 0.755 | / | ¹³ |
| T2-g | 3425 | 1428 | 0.417 | 227 | ¹⁴ |
| ZJU-HOF-10 | 1169 | 655 | 0.560 | 360 | ¹⁵ |
| PETHOF-1a | 1150 | 371 | 0.323 | 340 | ¹⁶ |
| PETHOF-2a | 1140 | 945 | 0.829 | 380 | ¹⁶ |
| CBPHAT-1a | 1288 | 1095 | 0.850 | 339 | ¹⁷ |
| B^{biphen}(2D) | 1080 | 1274 | 1.180 | 230 | ¹⁸ |
| tet-[2•(TP)₂]ₙ | 1473 | 1208 | 0.820 | 225 | ¹⁹ |
| Tcpb/HOF-BTB | 1095 | 1061 | 0.969 | 180 | ²⁰ |
| ZJU-HOF-1 | 1465 | 1269 | 0.866 | 200 | ²¹ |
| HOF-76a | 1121 | 1123 | 1.002 | 300 | ²² |
| ABTPA-2 | 1183 | 745 | 0.630 | 300 | ²³ |
| ThiaHAT-1a | 1394 | 1175 | 0.843 | 305 | ²⁴ |
| HOF-20a | 1323 | 1172 | 0.886 | 400 | ²⁵ |
| HOF-5a | 1101 | 1051 | 0.955 | 400 | ²⁶ |
| Trispyrazole-1 | 1159 | 1227 | 1.059 | 360 | ²⁷ |
| PFC-2 | 1014 | 529 | 0.522 | 400 | ²⁸ |
| RP-H100 | 2383 | 1573 | 0.660 | 375 | This work |
| RP-H101 | 3526 | 1855 | 0.526 | 375 | This work |

High-pressure H₂ sorption measurements. High-pressure sorption measurements of H₂ were measured on sc-CO₂ activated samples on an iSorb HP1 (Anton Paar) instrument, a computer-controlled Severts apparatus, at both Northwestern University and Anton Paar QuantaTec Inc (Florida). Gases used for adsorption measurements were ultra high purity (UHP) grade, 99.999% for H₂.
The sc-CO₂-activated samples were first degassed in the ASAP 2020 plus at 25° C. for 2 h, 90° C. for 2 h, and 140° C. for 12 h, and then ambient-pressure N₂ and H₂ isotherms were measured on the ASAP 2020 plus. Thereafter, for high-pressure measurements performed in Florida, the samples were removed from the sample cell for degassing and transferred into a microwave vial sealed with crimp capped for transporting. Then the samples were transferred into a precleaned, dried, and preweighed 2-ml microcell. Both RP-H100 and RP-H101 were degassed in situ at 45° C. for 2 h under a dynamic vacuum.
High-pressure adsorption isotherms were measured using a commercial Sieverts apparatus (iSorb, Anton Paar) controlled by a computer. In brief, the instrument operates in the temperature range of 35 to 50° C. for the manifold and −198 to 500° C. for the sample cell, with a pressure range from 0 to 100 bar. This equipment measured the excess adsorption of adsorbate gas using a volumetric method. The controlled amount of gas was dosed from a chamber named manifold under 45° C. with a known volume to the sample cell (at analysis temperature). For analysis at 77.3 K, the temperature was controlled by a liquid nitrogen control system, which automatically refills liquid nitrogen to maintain the liquid nitrogen level so as to keep the temperature of the sample constant throughout the measurements. For analysis at 296 and 270 K, the temperature was controlled using a circulator bath with an ethylene glycol/distilled H₂O mixture (50/50 vol. %) as the bath fluid. For sample analysis at 160 K, a cryocooler, a self-contained cooling system that can control the temperature from 15 to 320 K, was used. Throughout the whole measurement, both the temperature and pressure of the manifold and sample cell are recorded. The difference between the real analysis temperature and the setting temperature for all measurements was less than 0.02 K for the manifold and less than 0.5 K for the samples. The connection tubing between the manifold and sample cell has a filler rod inserted, providing a sharp temperature interface between the manifold and the sample cell.
The temperature variation was less than ±0.5 K. The errors in weighing samples and reading pressure were all less than 0.5%, from which the errors in overall results were less than 0.05 wt %, which is negligible. Errors can also arise from choosing the equation of state (EOS) for non-ideal gas conditions and from the temperature approximation for the connection tubing between the sample cell and the manifold. For He, the mBWR-Jacobsen EOS was used for data processing. For the data reduction of H₂, the MBWR EOS was used. [NIST Standard Reference Database 23: NIST Reference Fluid Thermodynamic and Transport Properties Database]. The errors of temperature approximation for the connection tubing between the sample cell and the manifold are more severe when the sample is measured at 77 K, at which temperature the connection region is under a sharp temperature gradient. We found that when there is a sharp temperature gradient in the connection region, separating the connection region into two zones, a cold zone and a warm zoom is better for void volume correction. In order to estimate and reduce the errors for measurements, we repeated all the sample measurements with the same cell but without the sample inside at the same pressure and same temperature, which gives “adsorption” of less than 0.05 mmol g⁻¹. During data reduction, a blank subtraction was performed for each sample measurement to subtract the adsorption amount contributed by the “adsorption” from the empty cell.
The void volumes of the empty cell were determined by helium expansion tests under both manifold temperature (45° C.) and sample analysis temperature after every blank measurement. After high-pressure gas sorption, the void volume of the cell with samples was determined again under both manifold temperature (45° C.) and sample analysis temperature. The void volumes were used for calculating the adsorbed amount of adsorbate.
It is worth noting that only the excess adsorption amount (Nₑₓ), the extra amount of gas adsorbed owing to the presence of adsorbents, is experimentally accessible directly, whilst absolute adsorption (N_{abs}) is the sum of excess adsorption (Nₑₓ) together with the amount of gas that would fill into the pore volume of the materials at the gas-phase density. The absolute adsorption amount can be calculated as follows:

$${N}_{a b s} = {N}_{ex} + {V}_{p} \cdot {\vec{n}}_{bulk} ( P , T )$$

In this equation, Vₚ (cm³ g⁻¹) is the pore volume of materials, which can be obtained from the N₂ isotherms at P/Pₒ=0.95, and ñ_{bulk} is the bulk density of the adsorbate at the temperature and pressure of the measurement. Here we use the experimentally measured bulk density from NIST²⁹. The gravimetric capacity (in wt %) of H₂ has been calculated based on wt %= (mass of H₂)/(mass of HOFs+mass of H₂)×100%. For consistency during comparison, we have converted the reported capacity in literature from wt %= (mass of H₂)/(mass of materials)×100% to wt %=(mass of H₂)/(mass of materials+mass of H₂)×100%. For the calculations of volumetric capacity, the crystallographic density was used³⁰.

TABLE 4
| The surface area, pore volume, density, H₂ deliverable capacities, and isosteric
heats of adsorption (Qₛₜ) for the MOFs from reported literature³¹ and HOFs in this work.

| | | | | | Deliverable H₂ | | | |
|---|---|---|---|---|---|---|---|---|
| | GSA | PV | Density | VSA | capacity^{a} | | Qₛₜ | |
| Materials | (m² g⁻¹) | (cm³ g⁻¹) | (g cm⁻³)^{b} | (m² cm⁻³) | (g L⁻¹)^{b} | (wt %)^{c} | (kJ mol⁻¹) | Ref. |
| MOF-5 | 3510 | 1.36 | 0.590 | 2070 | 51.9 | 7.8 | / | ³² |
| IRMOF-20 | 4070 | 1.65 | 0.510 | 2080 | 51 | 9.1 | / | ³² |
| NU-1101 | 4340 | 1.72 | 0.459 | 1990 | 47 | 9.1 | 5.5 | ³³ |
| NU-1102 | 3720 | 1.65 | 0.403 | 1500 | 44 | 9.6 | 4.5 | ³³ |
| NU-1103 | 6245 | 2.72 | 0.298 | 1860 | 43 | 12.6 | 3.8 | ³³ |
| NU-125 | 3230 | 1.33 | 0.578 | 1870 | 49 | 7.8 | 5.1 | ³⁴ |
| NU-1000 | 2200 | 1.48 | 0.571 | 1260 | 48 | 77 | 5 | ³⁴ |
| PCN-250 | 1780 | 0.71 | 0.896 | 1595 | 47 | 4.9 | 6.6 | ³⁴ |
| UiO-68-Ant | 3030 | 1.17 | 0.607 | 1840 | 47 | 72 | 6 | ³⁴ |
| HKUST-1 | 1980 | 0.75 | 0.881 | 1740 | 46 | 4.9 | 6.5 | ³⁴ |
| Zn(BDC)₂ | 2020 | 0.76 | 0.873 | 1760 | 42 | 4.6 | 4.9 | ³⁴ |
| (DABCO) | | | | | | | | |
| NOTT-112 | 3440 | 1.44 | 0.446 | 1530 | 41 | 8.3 | 5.1 | ³⁴ |
| CYCU-3-A1 | 2450 | 1.56 | 0.477 | 1170 | 41 | 8.0 | 4.5 | ³⁴ |
| UiO-67 | 2360 | 0.91 | 0.688 | 1620 | 41 | 5.7 | 5.8 | ³⁴ |
| Cu-MOF-74 | 1270 | 0.47 | 1.323 | 1680 | 39 | 2.9 | 5.6 | ³⁴ |
| rht-MOF-7 | 1950 | 0.79 | 0.789 | 1540 | 37 | 4.5 | 5.9 | ³⁴ |
| SNU-70 | 4940 | 2.14 | 0.411 | 2030 | 47.9 | 10.6 | / | ³⁵ |
| NU-100 | 6050 | 3 17 | 0.290 | 1755 | 47.6 | 13.9 | / | ³⁵ |
| UMCM-9 | 5040 | 2.31 | 0.370 | 1860 | 47.4 | 11.3 | / | ³⁵ |
| NU-1501-A1 | 7310 | 2.91 | 0.283 | 2060 | 46.2 | 14.0 | 4 | ³¹ |
| NU-1501-Fe | 7140 | 2.90 | 0.299 | 2130 | 45.4 | 13.2 | 4 | ³¹ |
| NU-1500-A1 | 3560 | 1.46 | 0.498 | 1770 | 44.6 | 8.2 | 4.9 | ³¹ |
| RP-H100 | 2383 | 1.11 | 0.660 | 1573 | 42.8 | 6.0 | 6.1 | This work |
| RP-H101 | 3526 | 1.35 | 0.526 | 1855 | 54.6 | 9.3 | 5 | This work |

^{a}Deliverable H₂ capacity is calculated by deducting the H₂ capacity at 160 K/5 bar from H₂ capacity at 77 K/100 bar.
^{b}Volumetric surface area and volumetric capacity (g L⁻¹) are calculated based on crystallographic density.
^{c}Gravimetric H₂ capacity (wt %) is calculated based on wt % = (mass of H₂)/(mass of H₂ + mass of adsorbents) × 100%.

### Section 7. Molecular Simulations

We performed grand canonical Monte Carlo (GCMC) simulations using the RASPA 2.0.37 software³⁶ to compute gas uptakes for H₂ and N₂ in HOFs. The Lennard-Jones (LJ) potential was used to describe dispersion and repulsion interactions between non-bonded atoms with the cut-off distance set to 12.8 Å and no tail corrections³⁷. LJ parameters for the HOF atoms were taken from the Universal Force Field (UFF)³⁸, and the Lorentz-Berthelot mixing rules were used to obtain LJ parameters between different pseudo-atoms. The long-range Coulombic interactions were calculated by Ewald summation³⁹ with a precision of 10⁻⁶. To estimate the partial atomic charges of the HOFs, we used the Density Derived Electrostatic and Chemical (DDEC6) method⁴⁰. Periodic boundary conditions were applied in all three dimensions, and the HOFs were assumed to be rigid during the simulations to save computational time. N₂ was represented as a three-site molecule in which two sites were positioned at the N atoms with charges of −0.4048, and the third site was at the centre of mass (com) with a partial point charge of 0.8096⁴¹. LJ sites were placed on the N atoms only, and the distance between the N atoms and the centre of mass was 0.55 Å. H₂ was modelled as a rigid, three-site molecule with the H—H bond length fixed at 0.741 Å. The centre of the mass site used LJ parameters from the model of Michels-Degraaff-Tenseldam⁴², and there were no LJ interactions for the other two sites. The H₂ model includes a point charge of −0.936 on the centre of mass and charges of 0.468 on the H nuclei⁴³. For Coulombic interactions during H₂ adsorption simulations, we neglected H₂-framework electrostatic interactions⁴⁴. We modified the H₂—H₂ and H₂-framework LJ interactions with the Feynman-Hibbs⁴⁵ correction to consider the quantum effect at cryogenic temperatures and the high densities of H₂. All LJ parameters are given in Table 5. Sample input files are included in the Supporting Information.
GCMC simulations for N₂ adsorption were performed at 77 K between 0.00001 and 1 bar. For the hydrogen storage applications, we performed GCMC simulations for H₂ adsorption and desorption at 77, 160, and 296 K at a pressure range of 0.00001-100 bar. The Peng-Robinson equation of state was utilized to calculate the fugacity for each adsorbed species at the investigated thermodynamic conditions⁴⁶. For each point on the isotherm, we used 5000 cycles for equilibration and 10,000 cycles for production. Translation, rotation, reinsertion, and swap (insertion/deletion) moves were utilized in the GCMC simulations for calculating pure gas uptakes. A cycle is a max (20, n) move attempt, with n being the number of adsorbed molecules³⁶.

TABLE 5
Force field parameters for HOF atoms
and guest adsorbate molecules.

| Pseudo-Atom | ε/k_{B} [K] | σ [Å] | mass (amu) |
|---|---|---|---|
| C (Framework) | 52.830 | 3.430 | 12.011 |
| H (Framework) | 22.140 | 2.570 | 1.008 |
| N (Framework) | 34.720 | 3.260 | 14.007 |
| O (Framework) | 30.190 | 3.120 | 15.999 |
| N—N₂ | 36.000 | 3.310 | 14.007 |
| N-com | 0.000 | 0.000 | / |
| H—H₂ | 0.000 | 0.000 | 2.016 |
| H-com | 36.700 | 2.958 | / |

### 7.1 Fixing Disorder in the Crystal Structure of RP-H100

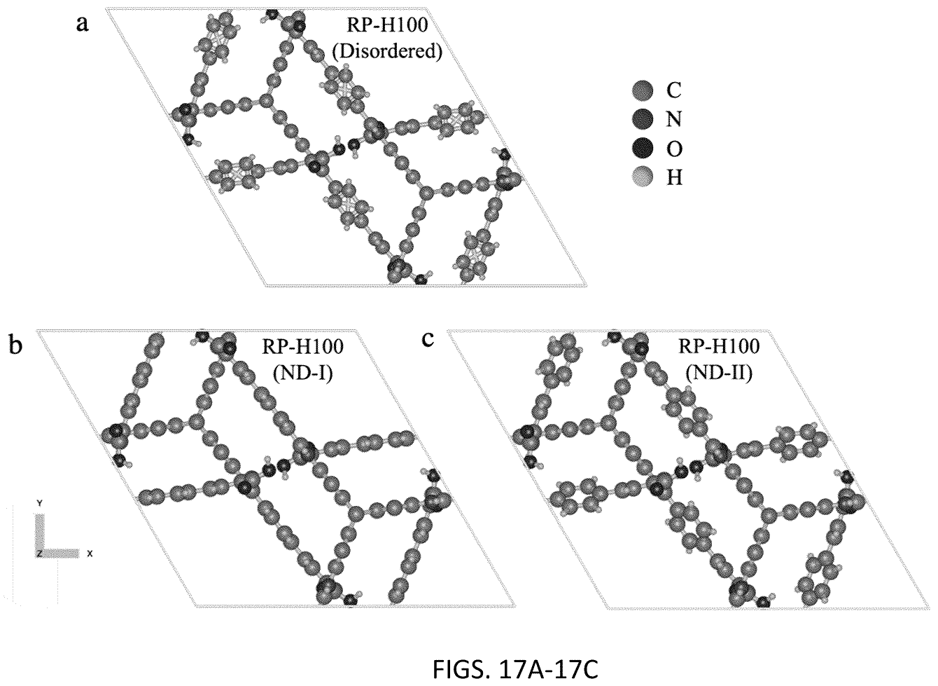

Since the initial crystallographic information file of RP-H100 contains disorders with partial occupancy of carbon (C) atom sites in the aromatic rings, we manually modified the structure by leaving a single representative atomic position for the C atoms. We generated two simulation-ready, non-disordered (ND) RP-H100 structures. The first was generated by taking the average positions of occupancy sites of C atoms (ND-I), and the second was created by deleting extra C atoms and keeping the aromatic ring as rotated (ND-II). The initial version of the benzene ring with disorder and two versions of non-disordered ones are shown in FIG. 17.

### 7.2 Density Functional Theory Calculations

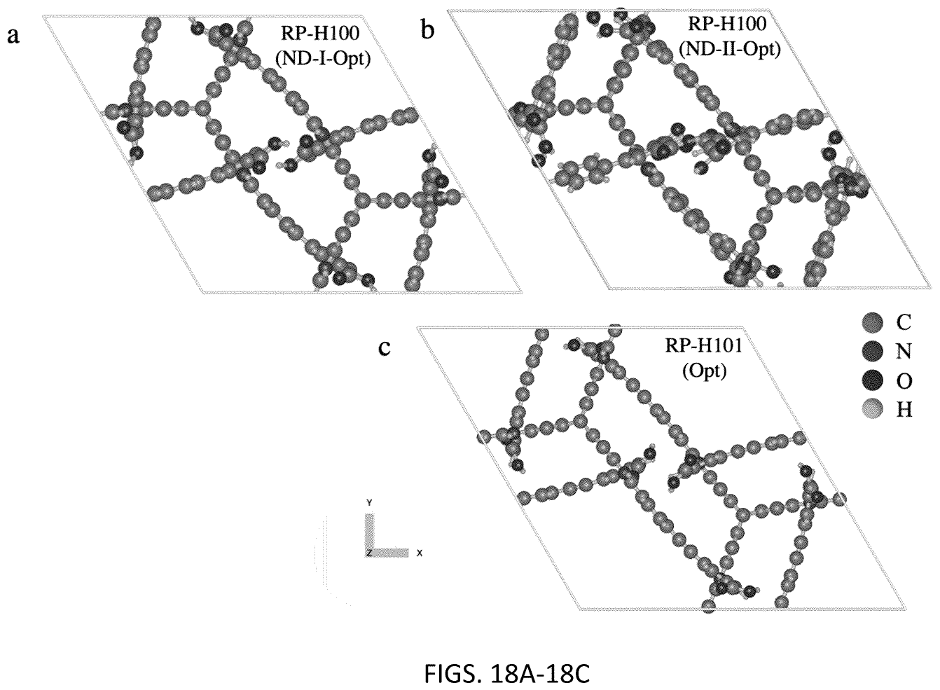

The structures ND-I and ND-II for RP-H100 and the experimentally determined structure of RP-H101 were relaxed using periodic density-functional theory (DFT) using the Vienna ab initio Simulation package (VASP) v.5.4.4^{47,48}. We considered the VASP-recommended v.54 projector-augmented waves (PAW) potentials for all elements⁴⁹. The cutoff energy was set to 600 eV for the plane-wave expansion of the wave function. The PBE density functional with D3(BJ) empirical dispersion correction was applied for geometry optimization calculations⁵⁰⁻⁵². Energy convergence was 10⁻⁶ CV for the SCF cycles, and the force convergence was set to 0.03 eV/Å for geometry optimization. The unit cell parameters were kept constant in the geometry optimization procedure. The Gamma point was used for sampling the first Brillouin zone, and 1×1×2 k-points were used for structures.
We performed the GCMC simulations for all structures, and we reported the simulated gas adsorption data of ND-I-Opt to represent RP-H100 in the main manuscript for the following reasons: (i) The final configuration of the ND-I-Opt is more similar to the configuration of the experimentally reported structure as shown in FIG. 18, (ii) the relative energy difference between the two optimized RP-H100 structures (E_{ND-I-Opt}-E_{ND-II-Opt}) is −11.57 KJ mol⁻¹, suggesting that ND-I-Opt structure is more stable than ND-II-Opt. In addition, since the experimentally reported crystal structure of RP-H101 does not contain any disorder, we reported the simulation results of the experimentally reported crystal structure of RP-H101 in the manuscript.

TABLE 6
| Calculated structural properties of HOFs.

| | | | | | | | | Unit cell |
|---|---|---|---|---|---|---|---|---|
| | | LCD | PLD | Density | | GSA | VSA | Volume |
| Structure | | (Å) | (Å) | (g cm⁻³) | VF | (m² g⁻¹) | (m² cm⁻³) | (Å³) |
| RP- | Original | 11.34 | 10.48 | 0.662 | 0.74 | 2042 | 1352 | 5507 |
| H100 | ND-I | 12.49 | 11.65 | 0.662 | 0.74 | 1926 | 1275 | 5507 |
| | ND-II | 12.26 | 10.48 | 0.662 | 0.73 | 2403 | 1591 | 5507 |
| | ND-I-Opt | 11.60 | 10.82 | 0.662 | 0.71 | 2034 | 1347 | 5507 |
| | ND-II-Opt | 11.95 | 11.09 | 0.662 | 0.70 | 2077 | 1375 | 5507 |
| RP- | Original | 15.36 | 14.15 | 0.527 | 0.80 | 3345 | 1763 | 7368 |
| H101 | DFT | 15.21 | 14.50 | 0.527 | 0.78 | 3197 | 1686 | 7368 |
| | optimized | | | | | | | |

Structural properties of HOFs such as the largest cavity diameter (LCD), pore limiting diameter (PLD), accessible gravimetric and volumetric surface area (GSA and VSA), density and pore volume were computed using Zeo++ v0.3⁵³, and helium void fraction (VF) was calculated by PoreBlazer v4.054. A nitrogen probe with a radius of 1.86 Å was used for calculating accessible surface areas. Pore volumes were computed using a probe radius of 0 Å and 5×10⁴ trials. The density of the original (disordered) RP-H100 was calculated using a weighted ratio of 0.5 for disordered C atoms, and the SA and VF of the structure were estimated based on the density. Table 6 shows that the SA values of the original RP-H100 are between the values of ND-I and ND-II and similar to them after the geometry optimization. The geometry-optimized structures of RP-H100 and RP-H101 generally have lower surface area than the unoptimized versions. This is expected due to additional factors, such as temperature, pressure, or the presence of solvent molecules, which may help to stabilize the experimental structures in a larger surface area⁵⁵.

To investigate the effect of these structural changes on adsorption properties, we calculated N₂ and H₂ adsorption isotherms for the two structures using both experimentally reported and DFT-optimized structures. Whilst the simulated adsorption isotherms for all derivatives of RP-H100 are slightly higher than the experimental one at the low-pressure region, ND-I of RP-H100 agrees well with the experimentally measured one at high pressure. For RP-H101, there is no clear difference between the N₂ simulation results of experimentally reported and optimized structures, and the simulated isotherm generally agrees well with the experimental isotherm, although there is a slight over-prediction at low pressure and under-prediction at high pressure.

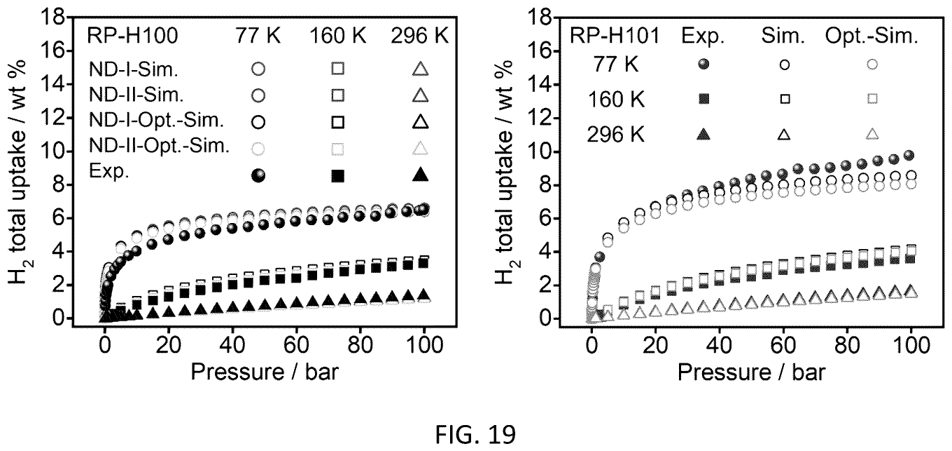

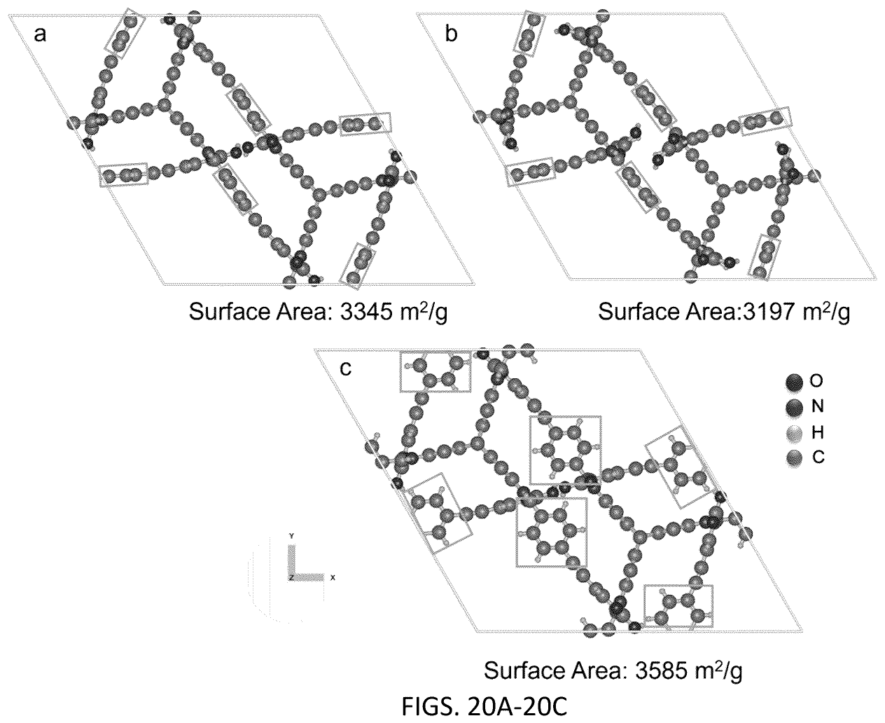

FIG. 19 compares the H₂ adsorption isotherms simulated with the different versions of RP-H100 and RP-H101 with experimental isotherms at 77, 160, and 296 K. The results show that the simulated isotherms of RP-H100 are slightly higher than the experimental isotherms up to 40 bar/77 K, whilst the results of RP-H101 slightly underestimate the experimental isotherms over 40 bar. When temperature increases, simulated adsorption isotherms agree better with experimental measurements. FIG. 19 also shows that the simulated H₂ adsorption isotherms computed by using the unoptimized structures of RP-H100 and RP-H101 are generally similar to those of optimized structures. The calculated heats of adsorption (Q) at low pressure (Table 7) show that there are moderate interactions between H₂ and framework atoms and are in good agreement with the experimental values.
FIG. 20 suggests that conformational changes in the crystal structure, such as the rotation of the phenylene rings of IATH-2 in RP-H101 or the shifting of the catenated frameworks relative to each other, can lead to changes in simulated surface areas. For instance, the phenylene ring of IATH-2, highlighted in orange boxes, can potentially rotate freely. The dihedral angles (between the rotatable phenylene ring and imidazole units) display an 8.6° difference between the single-crystal structure (FIG. 20A) of RP-H101 and its corresponding DFT-optimized structure (FIG. 20B), and there is a 148 m²/g difference in simulated surface areas between these two structures. Upon rotating the phenylene rings by 90° (as shown in FIG. 20C), a 7% increase in calculated surface area (from 3345 to 3585 m²/g) in the 90°-rotated structure is observed. Consequently, the difference between the simulated and experimental isotherms should be associated with conformational changes. It should also be kept in mind that the model parameters are not perfect: it is also possible that the limitations of the model are more apparent at high loading.

TABLE 7
The simulated heats of adsorption (Q) of H₂ at 296
K, 5 bar. Enthalpy of adsorption = −Q.

| HOFs | Q (kJ mol⁻¹) |
|---|---|
| RP-H100 | 6.75 ± 0.36 |
| RP-H101 | 5.64 ± 0.28 |

### Section 8. References for Sections 1-7

ADDIN EN.REFLIST 1. White, N. G. & MacLachlan, M. J. Soluble tetraaminotriptycene precursors. J. Org. Chem. 80, 8390-8397 (2015).
2. Dolomanov, O. V., Bourhis, L. J., Gildea, R. J., Howard, J. A. K. & Puschmann, H. Olex2: A complete structure solution, refinement and analysis program. J. Appl. Crystallogr. 42, 339-341 (2009).
3. Sheldrick, G. A short history of SHELX. Acta Crystallogr. A 64, 112-122 (2008).
4. Osterrieth, J. W. M. et al. How reproducible are surface areas calculated from the BET equation? Adv. Mater. 34, 2201502 (2022).
5. Song, X. et al. Design rules of hydrogen-bonded organic frameworks with high chemical and thermal stabilities. J. Am. Chem. Soc. 144, 10663-10687 (2022).
6. Yin, Q. et al. An ultra-robust and crystalline redeemable hydrogen-bonded organic framework for synergistic chemo-photodynamic therapy. Angew. Chem. Int. Ed. 57, 7691-7696 (2018).
7. Wang, Y. et al. Chemically engineered porous molecular coatings as reactive oxygen species generators and reservoirs for long-lasting self-cleaning textiles. Angew. Chem. Int. Ed. 61, e202115956 (2022).
8. Wang, B. et al. A novel mesoporous hydrogen-bonded organic framework with high porosity and stability. Chem. Commun. 56, 66-69 (2020).
9. Ma, K. et al. Ultrastable mesoporous hydrogen-bonded organic framework-based fiber composites toward mustard gas detoxification. Cell Rep. Phys. Sci. 1, 100024 (2020).
10. Hashim, M. I. et al. Dissecting porosity in molecular crystals: influence of geometry, hydrogen bonding, and [π . . . π] stacking on the solid-state packing of fluorinated aromatics. J. Am. Chem. Soc. 140, 6014-6026 (2018).
11. Suzuki, Y., Tohnai, N., Saeki, A. & Hisaki, I. Hydrogen-bonded organic frameworks of twisted polycyclic aromatic hydrocarbon. Chem. Commun. 56, 13369-13372 (2020).
12. Hu, F. et al. An ultrastable and easily regenerated hydrogen-bonded organic molecular framework with permanent porosity. Angew. Chem. Int. Ed. 56, 2101-2104 (2017).
13. Mastalerz, M. & Oppel, I. M. Rational construction of an extrinsic porous molecular crystal with an extraordinary high specific surface area. Angew. Chem. Int. Ed. 51, 5252-5255 (2012).
14. Pulido, A. et al. Functional materials discovery using energy-structure-function maps. Nature 543, 657-664 (2017).
15. Wang, J.-X., Gu, X.-W., Lin, Y.-X., Li, B. & Qian, G. A novel hydrogen-bonded organic framework with highly permanent porosity for boosting ethane/ethylene separation. ACS Mater. Lett. 3, 497-503 (2021).
16. Li, P. et al. Interpenetration isomerism in triptycene-based hydrogen-bonded organic frameworks. Angew. Chem. 131, 1678-1683 (2019).
17. Hisaki, I. et al. Docking strategy to construct thermostable, single-crystalline, hydrogen-bonded organic framework with high surface area. Angew. Chem. Int. Ed. 57, 12650-12655 (2018).
18. Boer, S. A., Morshedi, M., Tarzia, A., Doonan, C. J. & White, N. G. Molecular tectonics: A node-and-linker building block approach to a family of hydrogen-bonded frameworks. Chem. Eur. J. 25, 10006-10012 (2019).
19. Morshedi, M., Thomas, M., Tarzia, A., Doonan, C. J. & White, N. G. Supramolecular anion recognition in water: synthesis of hydrogen-bonded supramolecular frameworks. Chem. Sci. 8, 3019-3025 (2017).
20. Zentner, C. A. et al. High surface area and Z′ in a thermally stable 8-fold polycatenated hydrogen-bonded framework. Chem. Commun. 51, 11642-11645 (2015).
21. Zhang, X. et al. A rod-packing hydrogen-bonded organic framework with suitable pore confinement for benchmark ethane/ethylene separation. Angew. Chem. Int. Ed. 60, 10304-10310 (2021).
22. Zhang, X. et al. Selective ethane/ethylene separation in a robust microporous hydrogen-bonded organic framework. J. Am. Chem. Soc. 142, 633-640 (2020).
23. Cui, P. et al. An expandable hydrogen-bonded organic framework characterized by three-dimensional electron diffraction. J. Am. Chem. Soc. 142, 12743-12750 (2020).
24. Suzuki, Y. et al. Construction of isostructural hydrogen-bonded organic frameworks: limitations and possibilities of pore expansion. Chem. Sci. 12, 9607-9618 (2021).
25. Wang, B. et al. Microporous hydrogen-bonded organic framework for highly efficient turn-up fluorescent sensing of aniline. J. Am. Chem. Soc. 142, 12478-12485 (2020).
26. Wang, H. et al. A flexible microporous hydrogen-bonded organic framework for gas sorption and separation. J. Am. Chem. Soc. 137, 9963-9970 (2015).
27. Chen, T.-H. et al. Thermally robust and porous noncovalent organic framework with high affinity for fluorocarbons and CFCs. Nat. Commun. 5, 5131 (2014).
28. Yin, Q. et al. Novel hierarchical meso-microporous hydrogen-bonded organic framework for selective separation of acetylene and ethylene versus methane. ACS Appl. Mater. Interfaces 11, 17823-17827 (2019).
29. McCarty, R. D. & Arp, V. D. in Advances in Cryogenic Engineering: Part A& B 1465-1475 (Springer, 1990).
30. Chen, Z., Kirlikovali, K. O., Idrees, K. B., Wasson, M. C. & Farha, O. K. Porous materials for hydrogen storage. Chem 8, 693-716 (2022).
31. Chen, Z. et al. Balancing volumetric and gravimetric uptake in highly porous materials for clean energy. Science 368, 297-303 (2020).
32. Ahmed, A. et al. Balancing gravimetric and volumetric hydrogen density in MOFs. Energy & Environmental Science 10, 2459-2471 (2017).
33. Gómez-Gualdrón, D. A. et al. Understanding volumetric and gravimetric hydrogen adsorption trade-off in metal-organic frameworks. ACS Appl. Mater. Interfaces 9, 33419-33428 (2017).
34. García-Holley, P. et al. Benchmark study of hydrogen storage in metal-organic frameworks under temperature and pressure swing conditions. ACS Energy Lett. 3, 748-754 (2018).
35. Ahmed, A. et al. Exceptional hydrogen storage achieved by screening nearly half a million metal-organic frameworks. Nat. Commun. 10, 1568-1576 (2019).
36. Dubbeldam, D., Calero, S., Ellis, D. E. & Snurr, R. Q. RASPA: Molecular simulation software for adsorption and diffusion in flexible nanoporous materials. Mol. Simul. 42, 81-101 (2016).
37. Tee, L. S., Gotoh, S. & Stewart, W. E. Molecular parameters for normal fluids. Lennard-Jones 12-6 Potential. Ind. Eng. Chem. Fundam. 5, 356-363 (1966).
38. Rappé, A. K., Casewit, C. J., Colwell, K., Goddard III, W. A. & Skiff, W. M. UFF, a full periodic table force field for molecular mechanics and molecular dynamics simulations. J. Am. Chem. Soc. 114, 10024-10035 (1992).
39. Ewald, P. P. Die Berechnung optischer und elektrostatischer Gitterpotentiale. Ann. Phys. 369, 253-287 (1921).
40. Manz, T. A. & Sholl, D. S. Chemically meaningful atomic charges that reproduce the electrostatic potential in periodic and nonperiodic materials. J. Chem. Theory Comput. 6, 2455-2468 (2010).
41. Makrodimitris, K., Papadopoulos, G. K. & Theodorou, D. N. Prediction of permeation properties of CO₂ and N₂ through silicalite via molecular simulations. J. Chem. Phys. B 105, 777-788 (2001).
42. Michels, A., De Graaff, W. & Ten Seldam, C. Virial coefficients of hydrogen and deuterium at temperatures between-175° C. and +150° C. Conclusions from the second virial coefficient with regards to the intermolecular potential. Physica 26, 393-408 (1960).
43. Darkrim, F. & Levesque, D. Monte Carlo simulations of hydrogen adsorption in single-walled carbon nanotubes. J. Chem. Phys. 109, 4981-4984 (1998).
44. Bucior, B. J. et al. Energy-based descriptors to rapidly predict hydrogen storage in metal-organic frameworks. Mol. Syst. Des. Eng. 4, 162-174 (2019).
45. Liu, J. et al. Experimental and theoretical studies of gas adsorption in Cu3 (BTC) 2: an effective activation procedure. J. Phys. Chem. C 111, 9305-9313 (2007).
46. Peng, D.-Y. & Robinson, D. B. A new two-constant equation of state. Ind. Eng. Chem. Fundam. 15, 59-64 (1976).
47. Kresse, G. & Furthmüller, J. Efficient iterative schemes for ab initio total-energy calculations using a plane-wave basis set. Phys. Rev. B 54, 11169 (1996).
48. Kresse, G. & Joubert, D. From ultrasoft pseudopotentials to the projector augmented-wave method. Phys. Rev. B 59, 1758-1775 (1999).
49. Blöchl, P. E. Projector augmented-wave method. Phys. Rev. B 50, 17953 (1994).
50. Grimme, S., Ehrlich, S. & Goerigk, L. Effect of the damping function in dispersion corrected density functional theory. J. Comput. Chem. 32, 1456-1465 (2011).
51. Grimme, S., Antony, J., Ehrlich, S. & Krieg, H. A consistent and accurate ab initio parametrization of density functional dispersion correction (DFT-D) for the 94 elements H-Pu. J. Chem. Phys. 132 (2010).
52. Perdew, J. P., Burke, K. & Ernzerhof, M. Generalized gradient approximation made simple. Phys. Rev. Lett. 77, 3865 (1996).
53. Willems, T. F., Rycroft, C. H., Kazi, M., Meza, J. C. & Haranczyk, M. Algorithms and tools for high-throughput geometry-based analysis of crystalline porous materials. Microporous Mesoporous Mater. 149, 134-141 (2012).
54. Sarkisov, L., Bueno-Perez, R., Sutharson, M. & Fairen-Jimenez, D. Materials Informatics with PoreBlazer v4.0 and the CSD MOF Database. Chem. Mater. 32, 9849-9867 (2020).
55. Formalik, F., Neimark, A. V., Rogacka, J., Firlej, L. & Kuchta, B. Pore opening and breathing transitions in metal-organic frameworks: Coupling adsorption and deformation. J. Colloid Interface Sci. 578, 77-88 (2020).
56. Barnes, J. C. et al. A radically configurable six-state compound. Science 339, 429-433 (2013).
57. May, J. H., Van Raden, J. M., Maust, R. L., Zakharov, L. N. & Jasti, R. Active template strategy for the preparation of x-conjugated interlocked nanocarbons. Nat. Chem. 15, 170-176 (2023).
58. Cesario, M., Dietrich-Buchecker, C. O., Guilhem, J., Pascard, C. & Sauvage, J. P. Molecular structure of a catenand and its copper(I) catenate: complete rearrangement of the interlocked macrocyclic ligands by complexation. J. Chem. Soc., Chem. Commun., 244-247 (1985).
59. Nisanci, B. et al. Synthesis of an F-BODIPY [2]catenane using the chemistry of bis(dipyrrinato)metal complexes. Chem. Commun. 53, 12418-12421 (2017).

We claim:

1. A porous supramolecular crystal having a catenated superstructure.

2. The porous supramolecular crystal of claim 1, wherein the porous supramolecular crystal has a pore diameter from 1.0 to 1.9 nm.

3. The porous supramolecular crystal of claim 1, wherein the porous supramolecular crystal has a gravimetric surface area of at least 1500 m² g⁻¹.

4. The porous supramolecular crystal of claim 1, wherein the porous supramolecular crystal has a gravimetric surface area of at least 2000 m² g⁻¹.

5. The porous supramolecular crystal of claim 1, wherein the porous supramolecular crystal has a volumetric surface area of at least 1500 m² cm⁻³.

6. The porous supramolecular crystal of claim 1, wherein the porous supramolecular crystal has a volumetric surface area of at least 1800 m² cm⁻³.

7. The porous supramolecular crystal of claim 1, wherein the porous supramolecular crystal has a gravimetric capacity of at least 5.0 wt %.

8. The porous supramolecular crystal of clam 1, wherein the porous supramolecular crystal has a volumetric capacity of at least 30 g L⁻¹.

9. The porous supramolecular crystal of claim 1 having a thermal stability of at least 150° C.

10. The porous supramolecular crystal of claim 1, wherein the porous supramolecular crystal has a total pore volume of at least 0.8 cm³ g⁻¹.

11. The porous supramolecular crystal of claim 1, wherein the porous supramolecular crystal has two or more properties selected from the group selected from a pore diameter from 1.0 to 1.9 nm, a gravimetric surface area of at least 1500 m² g⁻¹, a volumetric surface area of at least 1500 m² g⁻¹, a gravimetric capacity of at least 5.0 wt %, a volumetric capacity of at least 30 g L⁻¹, a thermal stability of at least 150° C., and a total pore volume of at least 0.8 cm³ g⁻¹.

12. The porous supramolecular crystal of claim 1, wherein the porous supramolecular crystal comprises a plurality of triptycene moieties.

13. The porous supramolecular crystal of claim 7, wherein the plurality of triptycene moieties comprise a plurality of imidazole-annulated triptycene hexaacid moieties.

14. The porous supramolecular of claim 1, wherein the porous supramolecular crystal is prepared from IATH-1 or IATH-2.

15. The porous supramolecular crystal of claim 1, wherein the porous supramolecular crystal is RP-H101.

16. The porous supramolecular crystal of claim 1, wherein the porous supramolecular crystal is RP-H100.

17. The porous supramolecular crystal of claim 1, wherein the porous supramolecular crystal comprises D₃ₕ symmetry.

18. The porous supramolecular crystal of claim 1, wherein the porous supramolecular crystal comprises a 7-fold catenated topology.

19. The porous supramolecular crystal of claim 1, wherein catenated superstructure comprises a plurality of catenated components, wherein the catenated components have a primary surface (P) parallel to a normal direction (\vec{n}) and a secondary surface (S) perpendicular to the normal direction and the catenated components have a primary surface width (wₚ) that is wider than a secondary surface width (wₛ).

20. A method for storing hydrogen, the method comprising contacting the porous supramolecular crystal according to claim 1 with hydrogen under conditions sufficient for adsorbing hydrogen, optionally wherein the method further comprises desorbing the hydrogen.
